(19) United States
(12) Patent Application Publication
(10) Pub. No.: US 2024/0288680 A1
(43) Pub. Date: Aug. 29, 2024

(54) MEMS DEVICE, IN PARTICULAR OF MIRROR TYPE, WITH IMPROVED DETECTION OF THE DEFORMATION OF A DEFORMABLE STRUCTURE OF THE SAME, AND MANUFACTURING PROCESS OF THE MEMS DEVICE

(71) Applicant: STMicroelectronics International N.V., Geneva (CH)

(72) Inventors: Roberto CARMINATI, Piancogno (BS) (IT); Tarek AFIFI AFIFI, Milano (IT); Carlo Luigi PRELINI, Seveso (IT); Sonia COSTANTINI, Missaglia, Lecco (IT)

(73) Assignee: STMicroelectronics International N.V., Geneva (CH)

(21) Appl. No.: 18/584,533

(22) Filed: Feb. 22, 2024

(30) Foreign Application Priority Data
Feb. 27, 2023 (IT) 102023000003498

(51) Int. Cl. G02B 26/08; G01B 7/16; G02B 26/10

(52) U.S. Cl. CPC G02B 26/0833; G01B 7/22; G02B 26/101

(57) ABSTRACT

A MEMS device includes a semiconductor body with a fixed structure defining a cavity, and a deformable main body suspended on the cavity. A piezoelectric actuator is on the deformable main body, and a piezoelectric sensor element is on the deformable main body, which forms with the deformable main body a strain sensor. The piezoelectric sensor element includes a detection piezoelectric region of aluminum nitride on the deformable main body, and an intermediate detection electrode on the detection piezoelectric region. The deformable main body, the detection piezoelectric region, and the intermediate detection electrode form a first detection capacitor of the strain sensor. The deformable main body, the piezoelectric actuator, and the piezoelectric sensor element form a deformable structure suspended on the cavity and deformable by the piezoelectric actuator, with the strain sensor allowing the deformation of the deformable structure to be detected.

### PRIORITY CLAIM

This application claims the priority benefit of Italian Application for Patent No. 102023000003498 filed on Feb. 27, 2023, the content of which is hereby incorporated by reference in its entirety to the maximum extent allowable by law.

### TECHNICAL FIELD

This disclosure relates to a MEMS device, in particular a mirror type MEMS device, with improved detection of the deformation of a deformable structure of the MEMS device, and relates to a manufacturing process for the MEMS device. In particular, this disclosure relates to a MEMS device comprising a deformable structure which includes a piezoelectric actuator for controlling the deformation of the deformable structure, and a strain sensor for improved detection of the deformation of the deformable structure. This disclosure also relates to a manufacturing process for the MEMS device, to an operating method for the MEMS device, and to an electronic apparatus comprising the MEMS device.

### BACKGROUND

As is known, micro-electro-mechanical systems (MEMS) devices are commonly used and marketed, such MEMS devices comprising a tiltable structure, for example a mirror structure, formed with the technology of semiconductor materials.

For example, MEMS devices having mirror structure are for example used in portable apparatuses, such as portable computers, laptops, notebooks (comprising ultra-thin notebooks), PDAs, tablets, smartphones, for optical applications. In particular, they may be used to direct, in desired modes, light radiation beams generated by a light source in on-screen or LIDAR-type display applications.

Thanks to their small size, these devices allow meeting stringent requirements regarding device dimension, both in terms of area and thickness.

For example, MEMS mirror devices are used in miniaturized projector modules (so-called picoprojectors), capable of projecting images at a distance or generating desired light patterns.

MEMS mirror devices generally include a mirror element suspended over a cavity and a deformable structure which elastically couples the mirror element to an anchoring structure of the MEMS mirror device. The mirror element is formed starting from a semiconductor material body in such a way as to be movable, typically with a tilting or rotation movement, to direct the impinging light beam in a desired manner. Generally, the mirror element is controlled and rotated by piezoelectric-type or capacitive-type actuators, which are part of the deformable structure.

In order to allow better control of the mirror element and, accordingly, of the light beam directed thereby, it is known to couple one or more strain sensors, configured to detect the deformation of the deformable structure, to the mirror element in order to allow the position of the mirror element to be determined. This allows, for example, the mirror element to be controlled in closed-loop mode, operating the actuators as a function of the detected position of the mirror element. Accordingly, the use of strain sensors allows a more accurate control of the position of the mirror element.

For this purpose, it is known, for example, to use piezoresistive sensors to detect the position of the mirror element. In particular, such piezoresistive sensors comprise sensitive elements of semiconductor material (e.g., silicon) whose electrical resistance is a function of a mechanical deformation of these sensitive elements. Accordingly, when the actuators generate a movement of the mirror element, they also cause the mechanical deformation of the sensitive elements which is detected as a voltage/current variation across the sensitive elements. However, piezoresistive sensors have low measurement sensitivities (e.g., lower than about 3 mV/deg), high electrical consumption, require additional manufacturing steps and therefore higher production costs and times, and are highly dependent on temperature variations (e.g., −0.25%/° C.). Because of this, using piezoresistive sensors requires complex calibration procedures to balance the thermal effects to which these sensors may be subject, and in general causes the measurement accuracy to be limited.

Other known approaches are based on the use of a piezoelectric sensor with “single-ended” reading to detect the position of the mirror element. The piezoelectric sensor may comprise a respective sensitive element of piezoelectric insulating material (e.g., lead zirconate-titanate, PZT, or aluminum nitride, AlN) which biases, thus generating a potential difference thereacross, when subject to a mechanical deformation generated by the actuators to control the mirror element. Known approaches include reading this potential difference in “single-ended” mode, i.e. amplifying the potential difference, converting it into a respective digital signal by an ADC converter, and using this digital signal to determine the position of the mirror element and/or to control the “closed-loop” position thereof.

Similarly, there are also known approaches based on the use of multiple piezoelectric sensors with differential reading to detect the position of the mirror element. For example, these piezoelectric sensors have a structure similar to that described for the “single-ended” reading case and are arranged symmetrically with respect to the mirror element in such a way as to measure, in use, electrical signals which are in phase-opposition to each other and which therefore may be acquired in differential mode so as to improve the measurement sensitivity and increase the SNR, respectively in the “single-ended” case.

However, in both cases the piezoelectric sensors are generally formed, laterally to the actuators which are usually of piezoelectric type for easier integration in the manufacturing step with the piezoelectric sensors, or by manufacturing process steps which are additional with respect to those used to form the actuators or by the same manufacturing process steps used to form the actuators.

In the first case, this entails a greater complexity of the manufacturing process due to the greater number of manufacturing steps and lithographic masks used to form the device.

In the second case, this entails that the strain sensors and the actuators have similar physical structures (i.e. the vertical succession of the layers which form them is the same for both the strain sensors and the actuators). Furthermore, the piezoelectric insulating material portions used by the actuators to generate the movement of the mirror element and the piezoelectric insulating material portions used by the piezoelectric sensors to detect the movement of the mirror element are part of a same piezoelectric insulating material layer, i.e. are formed starting from the same piezoelectric insulating material (e.g., PZT) layer which is first deposited and then patterned to form the different portions used for the different detection or actuation uses. This generates an additional limit in the device design, as the piezoelectric insulating material used for detecting and actuating is to be the same for both actuators and piezoelectric sensors. This limit is particularly relevant when piezoelectric insulating materials such as PZT are chosen, as this prevents obtaining a device wherein both actuation and detection are optimized. In fact, PZT is known to become unstable over time due to phenomena such as piezoelectric fatigue and “depoling”, which may significantly affect the detection of the position of the mirror element. Furthermore PZT has hysteresis and also has a high dielectric constant (e.g., comprised between about 1000 C²/(N·m²) and about 1200 C²/(N·m²)). Thus, although PZT does not have relevant problems when used for actuation purposes (where the contact areas between PZT and respective electrodes are generally large), this material may be limiting when used for detection purposes (where the contact areas between PZT and respective electrodes are generally reduced) since it may lead to an excessively noisy and inaccurate measurement and to an excessive reduction of the SNR and of the amplitude of the output signal generated by the strain sensor.

There is a need in the art to provide a MEMS device, a manufacturing process of the MEMS device, an operating method of the MEMS device and an electronic apparatus comprising the MEMS device, which overcome the drawbacks of the prior art.

### SUMMARY

There is provided a MEMS device, a manufacturing process of the MEMS device, an operating method of the MEMS device and an electronic apparatus comprising the MEMS device.

To that end, disclosed herein is a MEMS device, including: a semiconductor body with a fixed structure and a deformable main body, the fixed structure defining a cavity in the semiconductor body and the deformable main body being fixed to the fixed structure and suspended over the cavity; a piezoelectric actuator extending over the deformable main body; and a piezoelectric sensor element which extends over the deformable main body, laterally to the piezoelectric actuator, and which forms, with the deformable main body, a strain sensor.

The piezoelectric sensor element includes: a detection piezoelectric region of aluminum nitride, extending over the deformable main body; and an intermediate detection electrode extending over the detection piezoelectric region.

The deformable main body, the detection piezoelectric region, and the intermediate detection electrode form a first detection capacitor of an active detection structure of the strain sensor, the deformable main body being configured to operate as a bottom detection electrode of the first detection capacitor. The deformable main body, the piezoelectric actuator, and the piezoelectric sensor element form a deformable structure suspended on the cavity. The piezoelectric actuator is electrically controllable to generate a deformation of the deformable structure.

The active detection structure of the strain sensor is configured to generate, in response to the deformation of the deformable structure, a first detection electric voltage between the bottom detection electrode and the intermediate detection electrode of the first detection capacitor, the first detection electric voltage being indicative of the deformation of the deformable structure.

The piezoelectric sensor element may also include: a passivation region of insulating material, extending over the intermediate detection electrode; a first detection electrical connection of conductive material, extending through the passivation region of the piezoelectric sensor element and in electrical contact with the intermediate detection electrode; and a second detection electrical connection of conductive material, extending through the passivation region of the piezoelectric sensor element, in electrical contact with the deformable main body and electrically insulated from the first detection electrical connection.

The passivation region may be monolithic and formed of aluminum nitride.

The piezoelectric sensor element may further include a top detection electrode extending over the passivation region.

The top detection electrode, the passivation region, and the intermediate detection electrode may form a second detection capacitor of the active detection structure of the strain sensor, the first detection capacitor and the second detection capacitor being electrically connected in series with each other.

The active detection structure of the strain sensor may be further configured to generate, in response to the deformation of the deformable structure, a second detection electric voltage between the intermediate detection electrode and the top detection electrode of the second detection capacitor, the second detection electric voltage being indicative of the deformation of the deformable structure.

The deformable main body may be formed of doped semiconductor material and has an electrical resistivity no more than 30 mΩ·cm.

The piezoelectric actuator may include: an insulating piezoelectric region of aluminum nitride, extending over the deformable main body laterally to the detection piezoelectric region; an intermediate actuation electrode of conductive material, extending over the insulating piezoelectric region; an actuation piezoelectric region of piezoelectric material, extending over the intermediate actuation electrode; and a top actuation electrode of conductive material, extending over the actuation piezoelectric region. The intermediate actuation electrode, the actuation piezoelectric region, and the top actuation electrode may form an actuation capacitor of an active actuation structure of the piezoelectric actuator.

The piezoelectric actuator may also include: a respective passivation region of insulating material, extending over the top actuation electrode; a first actuation electrical connection of conductive material, extending through the passivation region of the piezoelectric actuator and in electrical contact with the top actuation electrode; and a second actuation electrical connection of conductive material, extending through the passivation region of the piezoelectric actuator and electrically insulated from the first actuation electrical connection. The second actuation electrical connection may be in electrical contact with the deformable main body and with the intermediate actuation electrode.

The piezoelectric actuator may also include: a respective passivation region of insulating material, extending over the top actuation electrode; a first actuation electrical connection of conductive material, extending through the passivation region of the piezoelectric actuator and in electrical contact with the top actuation electrode; and a second actuation electrical connection of conductive material, extending through the passivation region of the piezoelectric actuator and electrically insulated from the first actuation electrical connection. The second actuation electrical connection may be in electrical contact with the intermediate actuation electrode and the piezoelectric actuator may further include a third actuation electrical connection of conductive material, which extends through the passivation region of the piezoelectric actuator, is electrically insulated from the first actuation electrical connection and the second actuation electrical connection and is in electrical contact with the deformable main body.

The MEMS device may be of mirror type and further includes: a tiltable structure elastically suspended on the cavity; a first support arm and a second support arm extending between the fixed structure and opposite sides of the tiltable structure, along a rotation axis of the tiltable structure; and a plurality of said deformable structures which face opposite sides of the first support arm, extend between the fixed structure and said opposite sides of the first support arm, and are electrically controllable to deform mechanically to thereby generate a rotation of the tiltable structure around the rotation axis.

The strain sensors of the deformable structures may be opposite to each other with respect to the rotation axis. When the tiltable structure rotates around the rotation axis due to the deformable structures, the strain sensors of the deformable structures may undergo respective mechanical deformations and generate respective detection signals which are indicative of the rotation of the tiltable structure around the rotation axis and are in phase-opposition to each other.

The MEMS device may be of mirror type and further include: a tiltable structure elastically suspended on the cavity; a first support arm and a second support arm extending between the fixed structure and opposite sides of the tiltable structure, along a rotation axis of the tiltable structure; and a plurality of said deformable structures which face opposite sides of the first support arm, extend between the fixed structure and the tiltable structure, and are electrically controllable to deform mechanically to thereby generate a rotation of the tiltable structure around the rotation axis.

The strain sensors of the deformable structures may be opposite to each other with respect to the rotation axis. When the tiltable structure rotates around the rotation axis due to the deformable structures, the strain sensors of the deformable structures may undergo respective mechanical deformations and generate respective detection signals which are indicative of the rotation of the tiltable structure around the rotation axis and are in phase-opposition to each other.

Also disclosed herein is a method of manufacturing a MEMS device, including steps of: a. forming a first piezoelectric layer of aluminum nitride on a first surface of a work wafer comprising a bottom semiconductive region of semiconductor material and a top semiconductive region of semiconductor material, superimposed along a first axis on the bottom semiconductive region of the work wafer and defining said first surface of the work wafer, the work wafer also having a second surface opposite to the first surface along the first axis; b. forming, on the first piezoelectric layer, a first conductive layer of conductive material; f. patterning, by chemical etching, the first conductive layer so as to form an intermediate detection electrode of a strain sensor; i. forming, by chemical etching, a first work trench through the first piezoelectric layer and up to, and exposing, the top semiconductive region of the work wafer, wherein the first work trench surrounds, orthogonally to the first axis, a portion of the first piezoelectric layer which underlies the intermediate detection electrode along the first axis and which forms a detection piezoelectric region; p. forming, by chemical etching, a planar profile trench through the top semiconductive region of the work wafer, the planar profile trench partially surrounding, orthogonally to the first axis, a portion of the top semiconductive region of the work wafer, underlying the detection piezoelectric region and adapted to form a deformable main body, and physically separating, orthogonally to the first axis, part of said portion of the top semiconductive region from a remaining part of the top semiconductive region of the work wafer in such a way as to define, orthogonally to the first axis, a planar profile of the deformable main body; and q. removing, by chemical etching performed starting from the second surface of the work wafer, a portion of the bottom semiconductive region of the work wafer underlying the deformable main body, up to exposing the top semiconductive region of the work wafer, in such a way as to form a cavity.

The method may further include, between steps b and f, the steps of: c. forming, on the first conductive layer, a second piezoelectric layer of piezoelectric material; d. forming, on the second piezoelectric layer, a second conductive layer of conductive material; and e. patterning, by chemical etching, the second conductive layer and the second piezoelectric layer in such a way as to form, respectively, a top actuation electrode and an actuation piezoelectric region underlying a top actuation electrode along the first axis. Step f further includes forming an intermediate actuation electrode of the piezoelectric actuator laterally to, and spaced from, an intermediate detection electrode of the strain sensor.

The method may include, between steps f and i, the step of forming a passivation region on the intermediate detection electrode of a piezoelectric sensor element, on a first detection electrical connection, and on a second detection electrical connection through the passivation region.

The step of forming the passivation region on the intermediate detection electrode and the first detection electrical connection and the second detection electrical connection through the passivation region comprises, between steps f and i, may include the steps of: g. forming a first insulating layer of insulating material on the intermediate detection electrode of the strain sensor and on the first piezoelectric layer; and h. forming a first electrical connection trench through the first insulating layer in such a way as to partially expose the intermediate detection electrode.

Step i may include forming the first work trench also through the first insulating layer, the first work trench also surrounding, orthogonally to the first axis, a portion of the first insulating layer, superimposed on the intermediate detection electrode along the first axis, which forms a first insulating passivation layer of the passivation region of the piezoelectric sensor element. Step i may further include forming a second electrical connection trench through the first insulating layer and the first piezoelectric layer in such a way as to partially expose the top semiconductive region of the work wafer.

The step of forming the passivation region on the intermediate detection electrode and the first detection electrical connection and the second detection electrical connection through the passivation region may also include, between steps i and p, the steps of: j. forming a third conductive layer of conductive material on the first insulating passivation layer of the passivation region of the piezoelectric sensor element, on the intermediate detection electrode and on the top semiconductive region of the work wafer; k. patterning, by chemical etching, the third conductive layer in such a way as to form, starting from the third conductive layer, a connection region of the first detection electrical connection in the first electrical connection trench, and a connection region of the second detection electrical connection in the second electrical connection trench; l. forming a second insulating layer of insulating material on the first insulating passivation layer, the first detection electrical connection and the second detection electrical connection, the second insulating layer defining a second insulating passivation layer of the passivation region of the piezoelectric sensor element and forming together with the first insulating passivation layer said passivation region of the piezoelectric sensor element; m. forming third electrical connection trenches through the second insulating layer in such a way as to partially expose the connection regions of the first detection electrical connection and the second detection electrical connection; and n. forming respective contact pads of the first detection electrical connection and the second detection electrical connection, of conductive material, in the third electrical connection trenches and in electrical contact with the respective connection regions, each contact pad forming with the respective connection region the first detection electrical connection or, respectively, the second detection electrical connection.

The step of forming the passivation region on the intermediate detection electrode and the first detection electrical connection and the second detection electrical connection through the passivation region may include steps of: g. forming a first insulating layer of aluminum nitride on the intermediate detection electrode of the strain sensor and on the first piezoelectric layer; and h. forming a first electrical connection trench through the first insulating layer in such a way as to partially expose the intermediate detection electrode.

Step i may include forming the first work trench also through the first insulating layer, the first work trench also surrounding, orthogonally to the first axis, a portion of the first insulating layer, superimposed on the intermediate detection electrode along the first axis, which forms the passivation region of the piezoelectric sensor element.

Step i may also include forming a second electrical connection trench through the first insulating layer and the first piezoelectric layer in such a way as to partially expose the top semiconductive region of the work wafer.

The step of forming the passivation region on the intermediate detection electrode and the first detection electrical connection and the second detection electrical connection through the passivation region may further include, between steps i and p, the steps of: j. forming a third conductive layer of conductive material on the passivation region of the piezoelectric sensor element, on the intermediate detection electrode and on the top semiconductive region of the work wafer; and k. patterning, by chemical etching, the third conductive layer in such a way as to form, starting from the third conductive layer, the first detection electrical connection in the first electrical connection trench, the second detection electrical connection in the second electrical connection trench and a top detection electrode on the passivation region of the piezoelectric sensor element.

The method may also include steps of: forming a tiltable structure elastically suspended on the cavity; forming a first support arm and a second support arm extending between a fixed structure and opposite sides of the tiltable structure, along a rotation axis of the tiltable structure; and forming a plurality of a deformable structures which face opposite sides of the first support arm, extend between the fixed structure and said opposite sides of the first support arm or between the fixed structure and the tiltable structure, and are electrically controllable to deform mechanically thereby generating a rotation of the tiltable structure around the rotation axis.

Strain sensors of the deformable structures may be opposite to each other with respect to the rotation axis. When the tiltable structure rotates around the rotation axis due to the deformable structures, the strain sensors of the deformable structures may undergo respective mechanical deformations and generate respective detection signals which are indicative of the rotation of the tiltable structure around the rotation axis and are in phase-opposition to each other.

### BRIEF DESCRIPTION OF THE DRAWINGS

For a better understanding, a preferred embodiment is now described, purely by way of non-limiting example, with reference to the attached drawings, wherein:

FIG. 1 schematically represents a lateral sectional view with suspended parts of a MEMS device provided with a tiltable structure and two deformable structures, according to a schematic embodiment of this disclosure;

FIGS. 2 and 3 are top views of respective embodiments of the MEMS device of FIG. 1;

FIGS. 4 and 5 are lateral sectional views with suspended parts illustrating details of the MEMS device of FIG. 1, according to respective embodiments;

FIGS. 6A-6R are lateral sectional views illustrating steps of a manufacturing process of the MEMS device of FIG. 1;

FIGS. 7 and 8 are lateral sectional views with suspended parts illustrating details of the MEMS device of FIG. 1, according to further embodiments; and

FIG. 9 is a block diagram which schematically shows an electronic apparatus comprising the MEMS device of FIG. 1.

In particular, the Figures are shown with reference to a triaxial Cartesian system defined by an axis X, an axis Y and an axis Z, orthogonal to each other.

### DETAILED DESCRIPTION

In the following description, elements common to the different embodiments have been indicated with the same reference numerals.

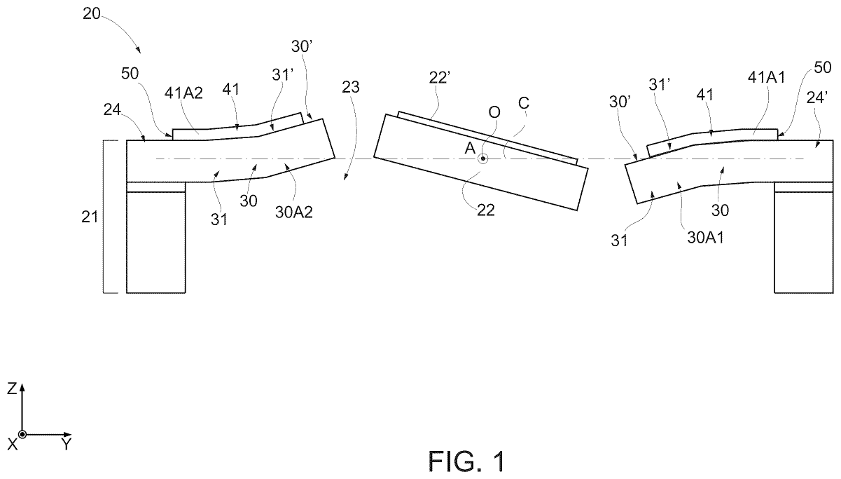

FIG. 1 schematically shows, in lateral sectional view in a plane YZ defined by the axes Y and Z, a MEMS device 20, in particular a MEMS mirror device.

The MEMS device 20 is formed in a semiconductor body 21. For example, the semiconductor body 21 may be a die of semiconductor material, in particular mono-crystalline or polycrystalline silicon, or a double structural layer, for example formed by a SOI (Silicon On Insulator) wafer.

The MEMS device 20 is provided with a tiltable structure 22, having main extension in a horizontal plane XY, defined by the axes X and Y, and arranged so as to rotate around a rotation axis A, parallel to the axis X.

The rotation axis A also represents a first symmetry median axis for the MEMS device 20, therefore also indicated by A; a second symmetry median axis C for the MEMS device 20 is parallel to the axis Y and passing through a center O of the tiltable structure 22.

The tiltable structure 22 is suspended above a cavity 23 formed in the semiconductor body 21 by a fixed structure 24 of the semiconductor body 21, which delimits the cavity 23. The tiltable structure 22 carries at the top a reflective surface 22′ of the MEMS device 20, so as to define a mirror structure comprising the tiltable structure 22 and the reflective surface 22′. The reflective surface 22′ is of material suitable for the application of the MEMS device 20, for example aluminum or gold, depending on whether the projection is in the visible or in the infrared.

The tiltable structure 22 is elastically coupled to an anchoring structure, here formed by a frame portion 24′ of the fixed structure 24, by a support structure comprising a first and a second support arm, not shown in FIG. 1, extending longitudinally along the first symmetry median axis A, above the cavity 23, between the frame portion 24′ of the fixed structure 24 and the tiltable structure 22, on opposite sides thereof. The support arms are equal to each other and arranged symmetrically with respect to the second symmetry median axis C.

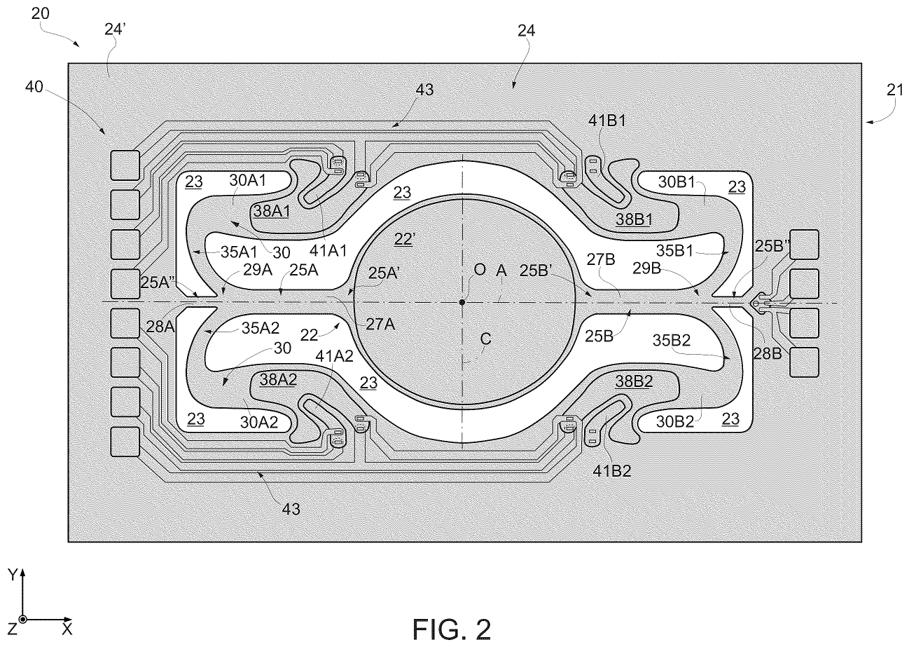

The MEMS device 20 further comprises a plurality of deformable structures 30 which, as shown in greater detail in FIG. 2, extend between the fixed structure 24 of the semiconductor body 21 and the mirror structure, on sides of the latter opposite to each other along the axis Y and have the respective deformable structures 30 facing thereon. In particular, the deformable structures 30 have a symmetrical structure with respect to the first symmetry median axis A.

The deformable structures 30 are coupled to the fixed structure 24 so as to be suspended above the cavity 23.

Each of them comprises a respective deformable main body 31, which is part of the semiconductor body 31 and is suspended above the cavity 23. Each deformable main body 31 is for example of semiconductor material. Each deformable main body 31 has a respective top surface 31′ which is not arranged facing the cavity 23, i.e. which is arranged facing the opposite side of the deformable main body 31 with respect to the cavity 23.

Furthermore, the deformable main body 31 has a first end and a second end, opposite to each other and not shown. The first end of the deformable main body 31 is fixed (therefore constrained) to the fixed structure 24 and the second end of the deformable main body 31 is fixed to the tiltable structure 22 and is suspended on the cavity 23 so as to be able to move relative to the fixed structure 24 (e.g., so as to be able to oscillate on the cavity 23).

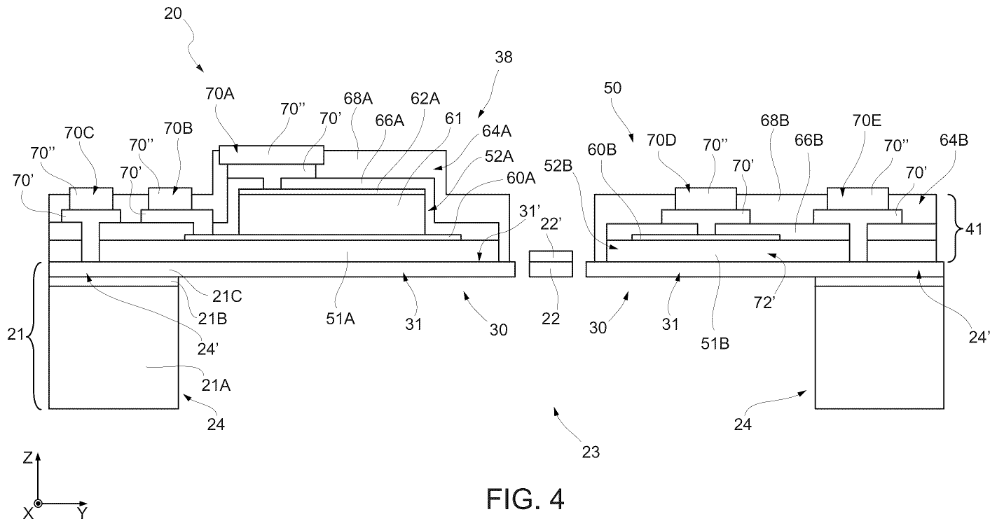

The deformable structures 30 also include, at their top surfaces 30′ (not arranged facing the cavity 23), respective piezoelectric actuators of the MEMS device 20, not shown in FIG. 1 but indicated hereinafter with the reference 38 (e.g., as shown in FIG. 4). The piezoelectric actuators 38 are electrically controllable to cause a mechanical deformation of the actuation structures which induces a torsion of the support arms around the first symmetry median axis A and, therefore, a displacement of the mirror structure (in detail, a rotation of the tiltable structure 22 around the first symmetry median axis A).

In particular, each piezoelectric actuator 38 extends over the top surface 31′ of the respective deformable main body 31, integrally with the deformable main body 31. Therefore, each piezoelectric actuator 38 is arranged facing the opposite side of the deformable main body with respect to the cavity 23.

Furthermore, the deformable structures 30 also include, at the top surfaces 30′, respective piezoelectric sensor elements (indicated in FIG. 1 with the references 41A1 and 41A2 and, more generally, with the reference 41 as for example shown in FIG. 4). The piezoelectric sensor elements 41 form, together with the respective deformable main bodies 31 whereon they extend, respective strain sensors 50 of piezoelectric type, as better discussed hereinbelow.

In particular, each piezoelectric sensor element 41 extends on the top surface 31′ of the respective deformable main body 31, integrally with the deformable main body 31 and so as to also be suspended on the cavity 23. Therefore, each piezoelectric sensor element 41 is arranged facing the opposite side of the deformable main body with respect to the cavity 23.

In more detail, the piezoelectric sensor elements 41 extend symmetrically with respect to the first symmetry median axis A.

FIG. 2 schematically shows the MEMS device 20, according to an embodiment similar to that shown in FIG. 1 and wherein the MEMS device 20 is designed to operate in a dynamic regime (i.e. in resonance, at rotation frequencies of the tiltable structure 22 higher than 10 kHz).

The MEMS device 20 is formed in the semiconductor body 21 and is provided with the tiltable structure 22.

The tiltable structure 22 is suspended above the cavity 23 and carries at the top the reflective surface 22′ which has, in the illustrated embodiment, a generically circular shape in the plane XY (although other shapes are possible, from an elliptical shape to a polygonal, for example square or rectangular, shape).

The tiltable structure 22 is elastically coupled to the frame portion 24′ of the fixed structure 24 by the support structure comprising the first and the second support arms, indicated in FIG. 2 with the references 25A, 25B. The support arms 25A, 25B extend longitudinally along the first symmetry median axis A, above the cavity 23, between the frame portion 24′ of the fixed structure 24 and the tiltable structure 22, on opposite sides thereof. The support arms 25A, 25B are equal to each other and arranged symmetrically with respect to the second symmetry median axis C.

In detail, the first support arm 25A has a first end 25A′ rigidly coupled to the tiltable structure 22 and a second end 25A″ rigidly coupled to the frame portion 24′ of the fixed structure 24 and comprises first and second torsional springs 27A, 28A. The first and second torsional springs 27A, 28A have a linear shape, extending in continuation with each other along the first symmetry median axis A between a first side of the tiltable structure 22 and a first side of the frame portion 24′ of the fixed structure 24.

The second support arm 25B has a first end 25B′ rigidly coupled to the tiltable structure 22 and a second end 25B″ rigidly coupled to the frame portion 24′ of the fixed structure 24, and comprises third and fourth torsional springs 27B, 28B. The third and fourth torsional springs 27B, 28B extend in continuation with each other along the first symmetry median axis A between a second side, opposite to the first, of the tiltable structure 22 and a second side, opposite to the first, of the frame portion 24′ of the fixed structure 24.

In detail, the torsional springs 27A, 27B, 28A, 28B each have a linear beam shape rigid for movements outside the plane XY and yielding to torsion around the first symmetry median axis A.

In the first support arm 25A, the first and the second torsional springs 27A, 28A are connected to each other at a first constraint structure 29A, that is rigid; in the second support arm 25B, the third and the fourth torsional springs 27B, 28B are connected to each other at a second constraint structure 29B, that is rigid.

The MEMS device 20 further comprises the plurality of deformable structures 30, in particular at least a first deformable structure and a second deformable structure 30A1 and 30A2 which extend between the frame portion 24′ of the fixed structure 24 and the first constraint structure 29A, on a first side and, respectively, a second side of the first support arm 25A, and which have a symmetrical structure with respect to the first symmetry median axis A. In detail, the first deformable structure 30A1 is coupled to the first constraint structure 29A through a coupling region 35A1 of the first deformable structure 30A1, extending along a main extension direction transverse with respect to a main extension direction of the remaining portion of the first deformable structure 30A1; similarly, the second deformable structure 30A2 is coupled to the first constraint structure 29A through a coupling region 35A2 of the second deformable structure 30A2, which extends along a respective main extension direction transverse with respect to a main extension direction of the remaining portion of the second deformable structure 30A2.

In FIG. 2, the plurality of deformable structures 30 further comprises third and fourth deformable structures 30B1 and 30B2, extending between the frame portion 24′ of the fixed structure 24 and the second constraint structure 29B, on a first side and, respectively, a second side of the second support arm 25B. The third and the fourth deformable structures 30B1 and 30B2 have a structure symmetrical to each other with respect to the first symmetry median axis A. In detail, the third deformable structure 30B1 is coupled to the second constraint structure 29B by a coupling region 35B1 of the third deformable structure 30B1, which extends along a respective main extension direction transverse with respect to a main extension direction of the remaining portion of the third deformable structure 30B1; similarly, the fourth deformable structure 30B2 is coupled to the second constraint structure 29B by a coupling region 35B2 of the fourth deformable structure 30B2 which extends along a respective main extension direction transverse with respect to a main extension direction of the remaining portion of the fourth deformable structure 30B2.

The deformable structures 30A1, 30A2, 30B1, and 30B2 are suspended above the cavity 23 and include, at their top surfaces 30′, the respective piezoelectric actuators 38, indicated in more detail in FIG. 2 with the respective references 38A1, 38A2, 38B1, 38B2. In particular, the piezoelectric actuators 38A1, 38A2, 38B1, 38B2 are based on the inverse piezoelectric effect and have a structure which is better discussed hereinbelow.

Furthermore, the deformable structures 30A1, 30A2, 30B1 include, at their top surfaces 30′, the plurality of piezoelectric sensor elements 41. In particular, they comprise the first and second piezoelectric sensor elements 41A1 and 41A2.

The first and second piezoelectric sensor elements 41A1 and 41A2 extend, for example, over the deformable main bodies 31 of the first and, respectively, the second deformable structure 30A1, 30A2 (alternatively and in a manner not shown, they extend over the deformable main bodies 31 of the third and, respectively, the fourth deformable structure 30B1, 30B2). By way of non-limiting example, the first and the second piezoelectric sensor elements 41A1 and 41A2 extend at the frame portion 24′ of the fixed structure 24.

Optionally, the plurality of piezoelectric sensor elements further comprises third and fourth piezoelectric sensor elements 41B1 and 41B2 extending over the deformable main bodies 31 of the third and, respectively, the fourth deformable structure 30B1, 30B2. For example, the third and the fourth piezoelectric sensor elements 41B1 and 41B2 extend at the frame portion 24′ of the fixed structure 24. In detail, if the third and the fourth piezoelectric sensor elements 41B1 and 41B2 are also present, they may be electrically connected in series to the first and, respectively, the second piezoelectric sensor element 41A1 and 41A2.

Furthermore, the MEMS device 20 optionally comprises a plurality of electric contact pads 40, which in FIG. 2 are exemplarily carried by the frame portion 24′ of the fixed structure 24 and are electrically connected, by respective lines or vias 43, both to the piezoelectric actuators 38A1, 38A2, 38B1, 38B2, to allow the electrical bias thereof by actuation signals coming from the outside of the MEMS device 20, and to the first and the second piezoelectric sensor elements 41A1 and 41A2 (optionally, also to the third and the fourth piezoelectric sensor elements 41B1 and 41B2, if any), to allow the position of the mirror structure to be detected.

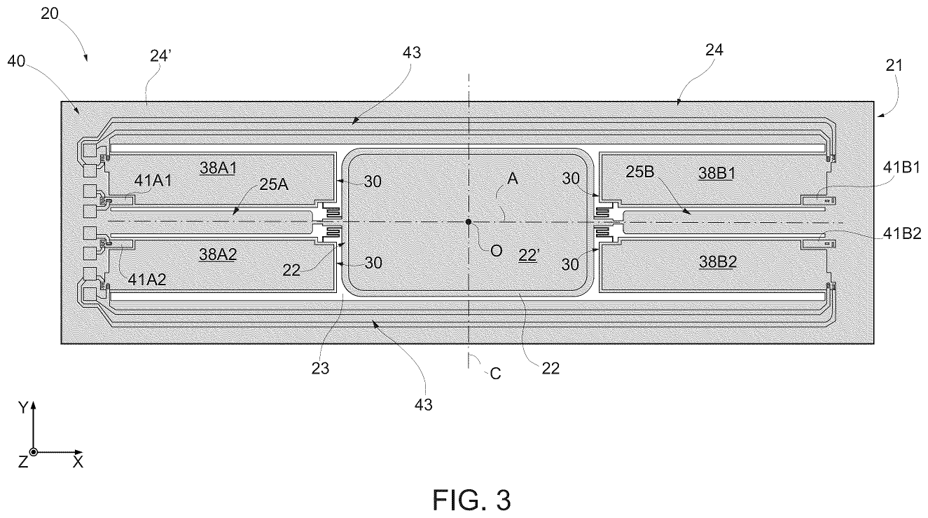

FIG. 3 schematically shows the MEMS device 20, according to a further embodiment wherein the MEMS device 20 is designed to operate in a quasi-static regime (i.e. at rotation frequencies of the tiltable structure 22 lower than about 200 Hz).

In particular, the structure of the MEMS device of FIG. 3 is similar to that of FIG. 2, and therefore it will not be described again in detail herein.

However, in FIG. 3 the deformable structures 30 extend between the frame portion 24′ of the fixed structure 24 and the tiltable structure 22, on sides of the latter opposite to each other along the axis X. Therefore, the deformable structures 30 are directly coupled to the tiltable structure 22, and are not instead directly coupled to the support structure as described with reference to FIG. 2.

FIG. 4 schematically shows the MEMS device 20 of FIG. 1, with greater details regarding the piezoelectric actuators 38 and the strain sensors 50.

For purely illustrative and non-limiting purposes, FIG. 4 shows in the plane YZ two deformable structures 30 anchored to the frame portion 24′ of the fixed structure 24, suspended on the cavity 23 and respectively facing sides of the tiltable structure 22 which are opposite to each other along the axis Y. In other words, the tiltable structure 22 is interposed along the axis Y between the two deformable structures 30.

Purely by way of example, one of the two deformable structures 30 (e.g., the deformable structure 30 to the left of the tiltable structure 22) has a piezoelectric actuator 38 while the other of the two deformable structures 30 (e.g., the deformable structure 30 to the right of the tiltable structure 22) has a strain sensor 50. Nevertheless, this is done only for the purpose of simplifying the visualization, the description, and the mutual comparison of the piezoelectric sensor elements 41 and the piezoelectric actuators 38, and therefore it is not intended in a limiting sense. In fact, in general each deformable structure 30 comprises at least one piezoelectric actuator 38 and at least one piezoelectric sensor element 41, arranged side by side to each other; however, showing both these elements for each deformable structure 30 of FIG. 4 would have complicated and unnecessarily obscured the representation and understanding of the same Figure.

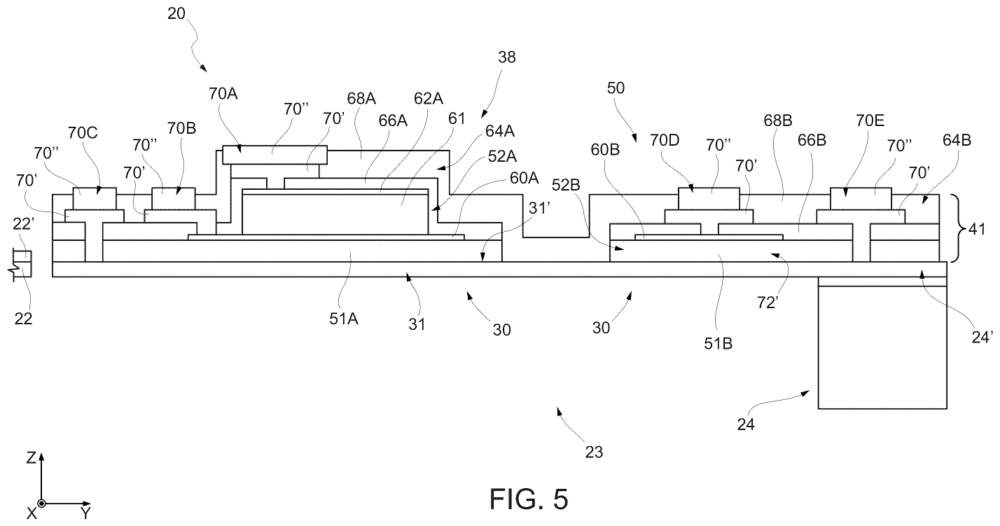

It is therefore evident that the position, the arrangement and the number of the piezoelectric sensor elements 41 and the piezoelectric actuators 38 on the deformable structures 30 may vary with respect to what is shown in FIG. 4, as previously discussed for example with reference to FIGS. 2 and 3. For example, FIG. 5 shows a similar and more realistic embodiment of the MEMS device 20 wherein a single deformable structure 30 is shown comprising a piezoelectric actuator 38 and a strain sensor 50, extending laterally to each other along the axis Y.

With reference to FIG. 4, the structures of the piezoelectric sensor element 41 and the piezoelectric actuator 38 are shown in detail.

With reference to the deformable structure 30 of FIG. 4 to the left of the tiltable structure 22, the piezoelectric actuator 38 extends over the top surface 31′ of the deformable main body 31, which is of semiconductor material such as monosilicon or polysilicon and is in particular doped (e.g., with a doping species such as phosphorus) in such a way as to be conductive (e.g., to have electrical resistivity lower than, or equal to, about 30 mΩ·cm).

For example, in the case of FIG. 4 the semiconductor body 21 comprises a double structural layer formed by a SOI (Silicon On Insulator) wafer, therefore it comprises a bottom semiconductive region 21A of semiconductor material such as silicon, an intermediate insulating region 21B of insulating material such as silicon dioxide, and a top semiconductive region 21C of semiconductor material such as silicon. The bottom semiconductive region 21A and the intermediate insulating region 21B laterally delimit the cavity 23 while the top semiconductive region 21C has a portion which is suspended over the cavity 23 and which forms the deformable main body 31.

The piezoelectric actuator 38 comprises an insulating piezoelectric region 51A, of piezoelectric material and in particular of aluminum nitride (AlN) (for example of intrinsic type or doped with one or more doping species such as scandium). The insulating piezoelectric region 51A is arranged on the deformable main body 31 so as to electrically insulate it from an active actuation structure 52A of the piezoelectric actuator 38.

In the embodiment of FIG. 4, the active actuation structure 52A of the piezoelectric actuator 38 extends over the insulating piezoelectric region 51A and comprises an actuation capacitor 56 formed by an actuation piezoelectric region 61, an intermediate actuation electrode 60A, and a top actuation electrode 62A.

The intermediate actuation electrode 60A is of conductive material, in particular metal material such as platinum, and extends over the insulating piezoelectric region 51A, in contact with the latter.

The actuation piezoelectric region 61 extends over the intermediate actuation electrode 60A and is formed by piezoelectric material, for example PZT (lead zirconate titanate), BaTiO₃, AlN, KNN (sodium potassium niobate), PbTiO₂ or PbNb₂O₆. For example, the actuation piezoelectric region 61 has a thickness of a few micrometers, for example comprised between 1 μm and 3 μm.

The top actuation electrode 62A is of conductive material, in particular a metal material such as platinum or a titanium and tungsten alloy, and extends over the actuation piezoelectric region 61.

The piezoelectric actuator 38 also comprises a passivation region 64A, of insulating material and with a passivation function. In detail, the passivation region 64A allows the active actuation structure 52A to be electrically insulated and protected from external contaminants.

The passivation region 64A is formed here, for example, by a stack of insulating layers. By way of example, this stack of insulating layers comprises a first insulating passivation layer 66A (for example of aluminum oxide or silicon oxide, arranged on the active actuation structure 52A, the insulating piezoelectric region 51A and the deformable main body 31) and a second insulating passivation layer 68A (for example of silicon nitride, SiN, arranged on the first insulating passivation layer 66A).

The piezoelectric actuator 38 further comprises electrical connections which allow the top actuation electrode 62A, the intermediate actuation electrode 60A, and the deformable main body 31 to be electrically controlled, in use.

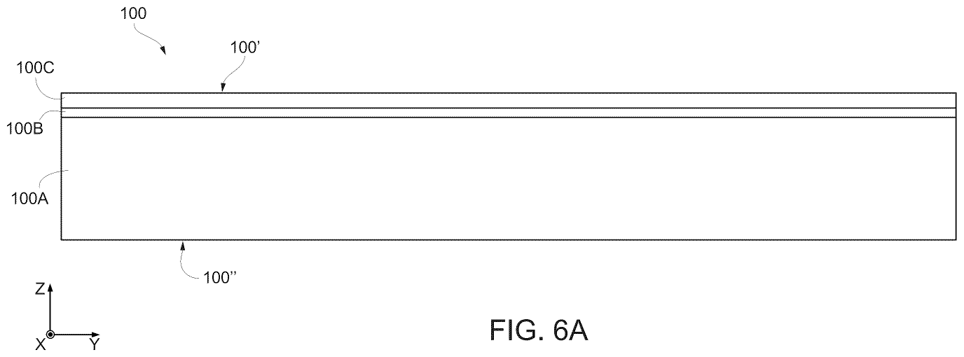

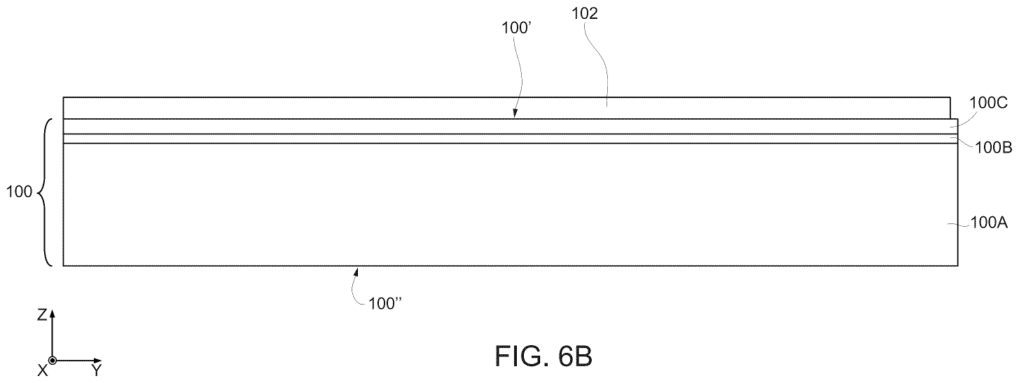

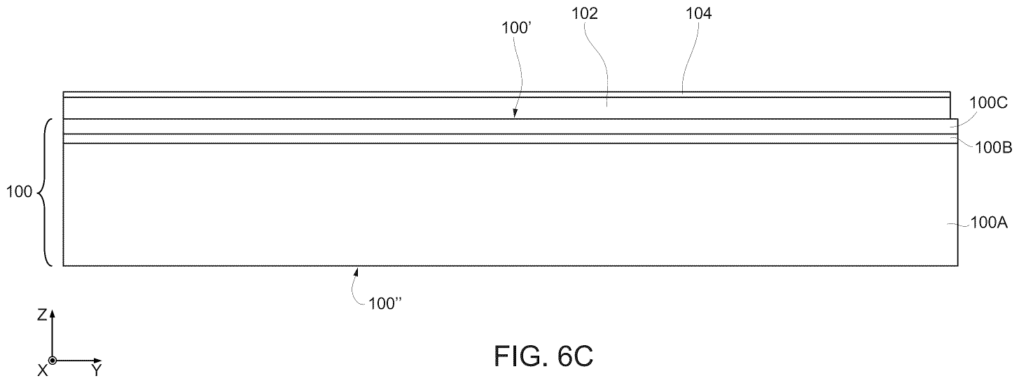

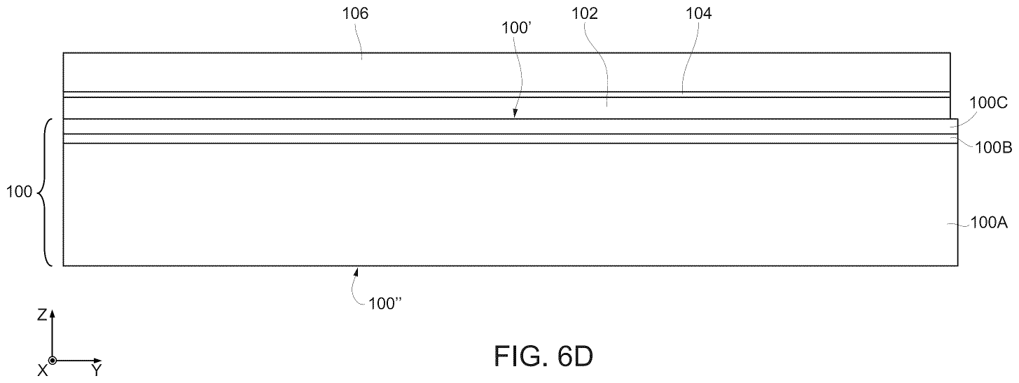

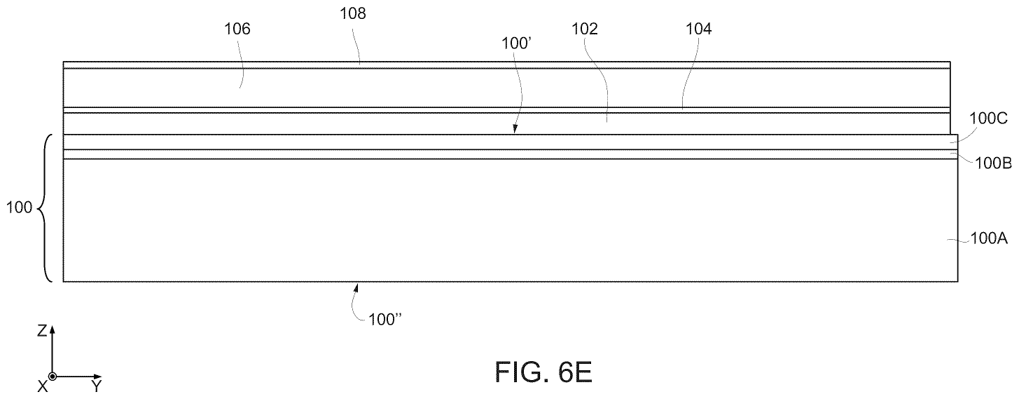

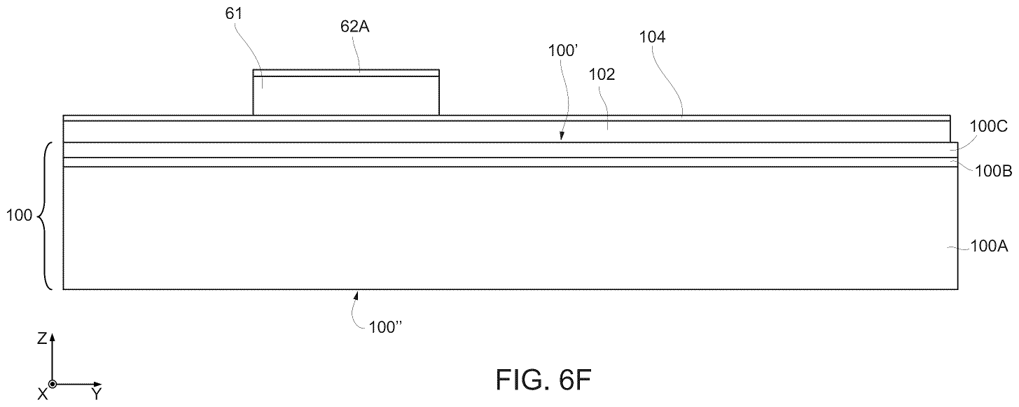

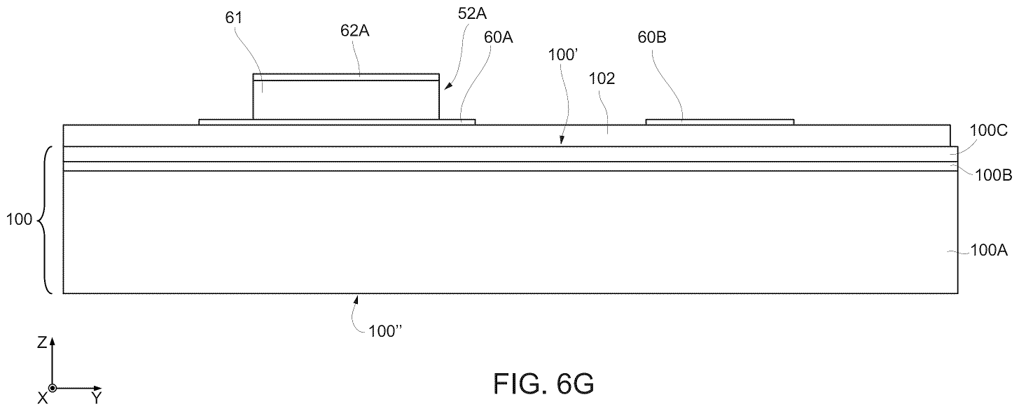

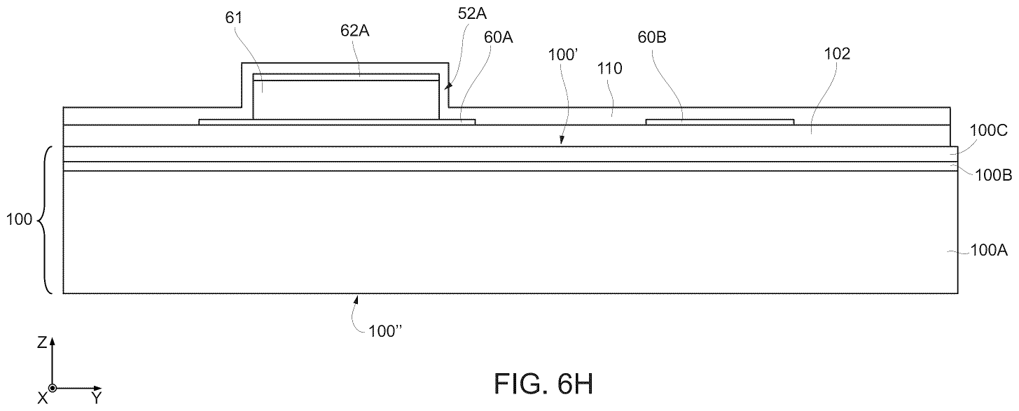

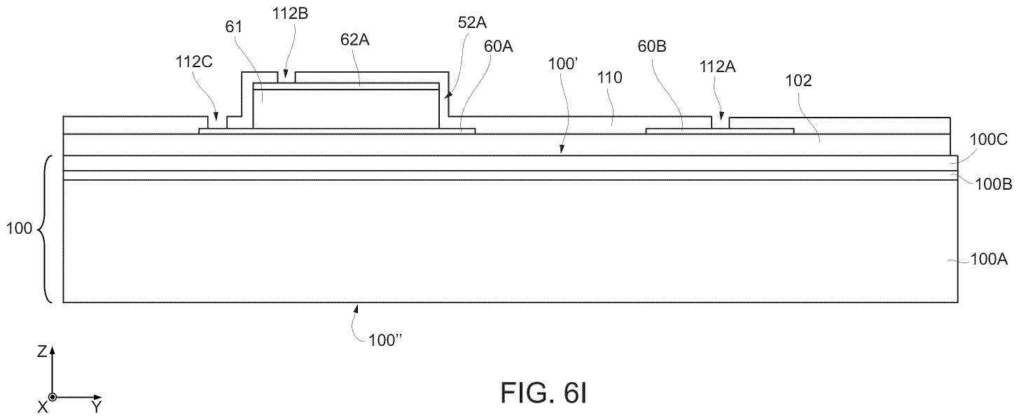

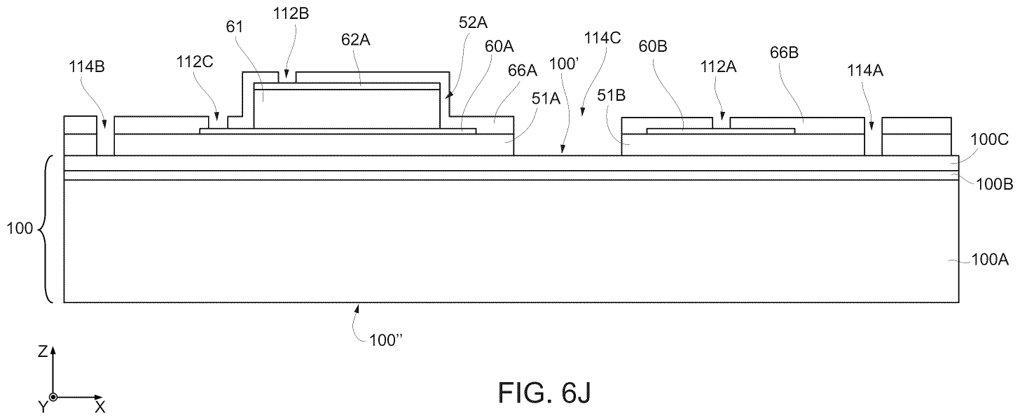

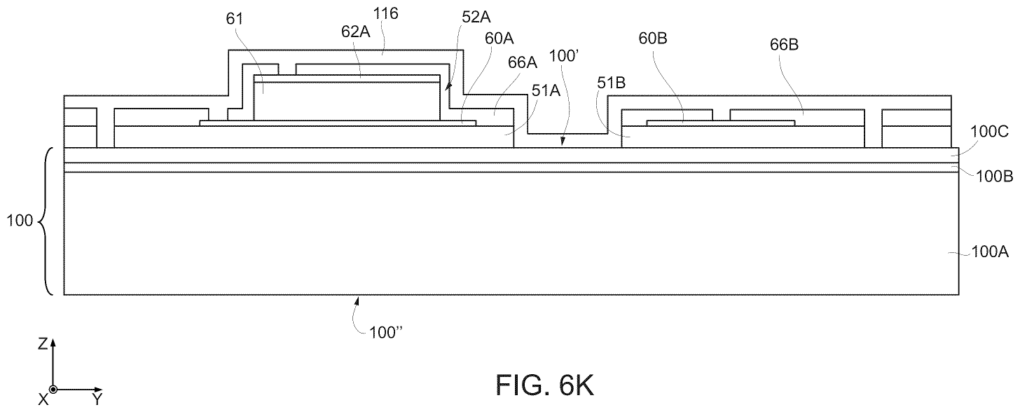

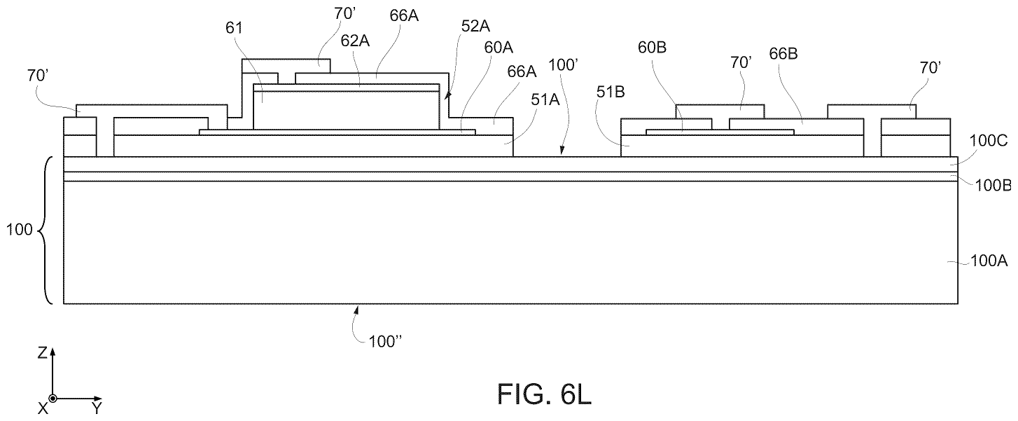

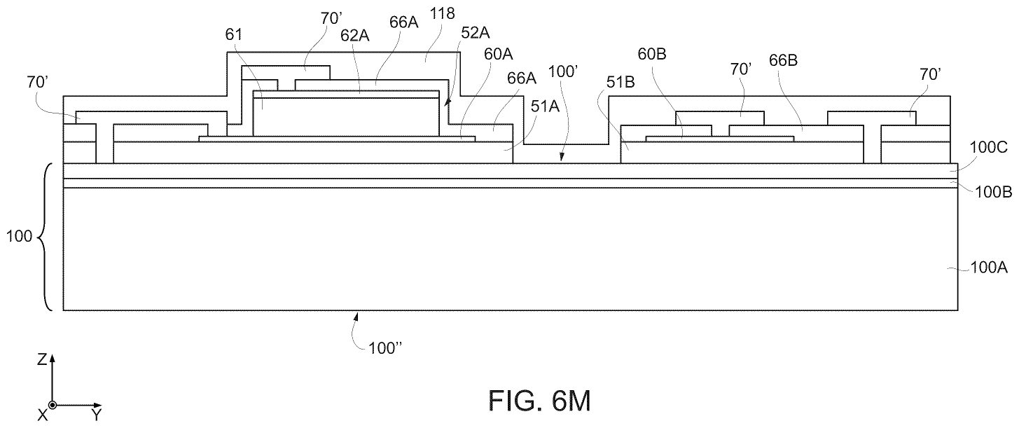

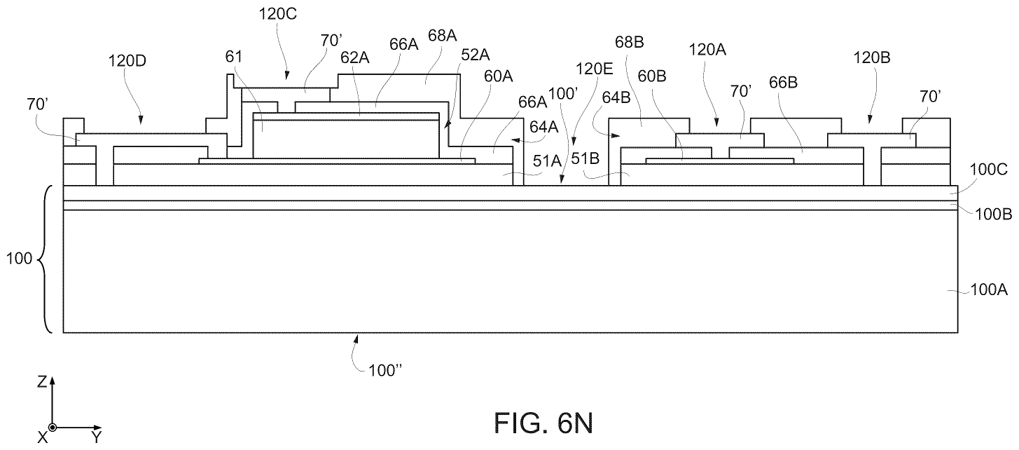

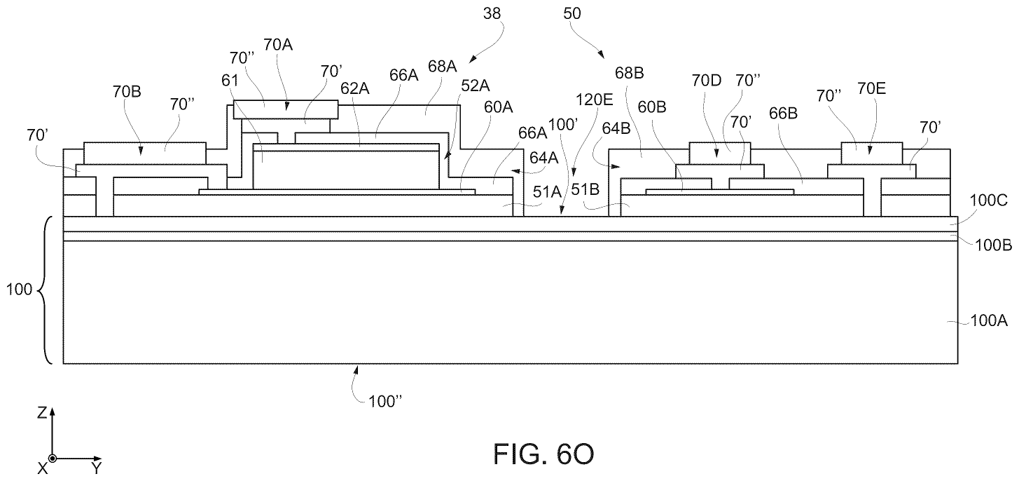

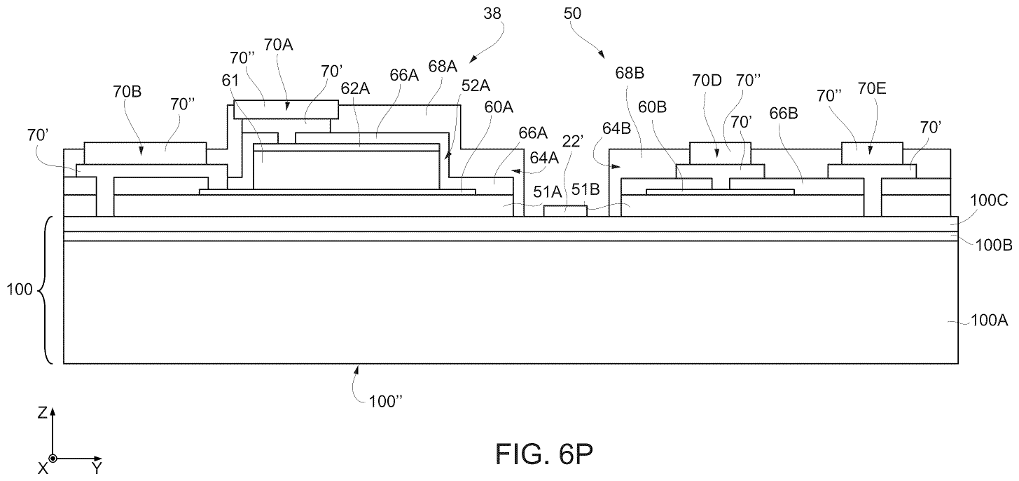

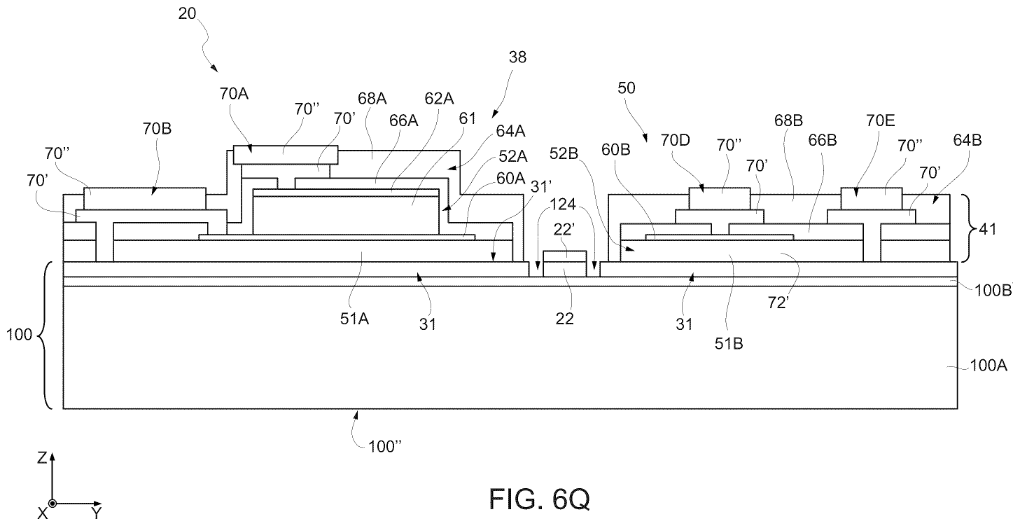

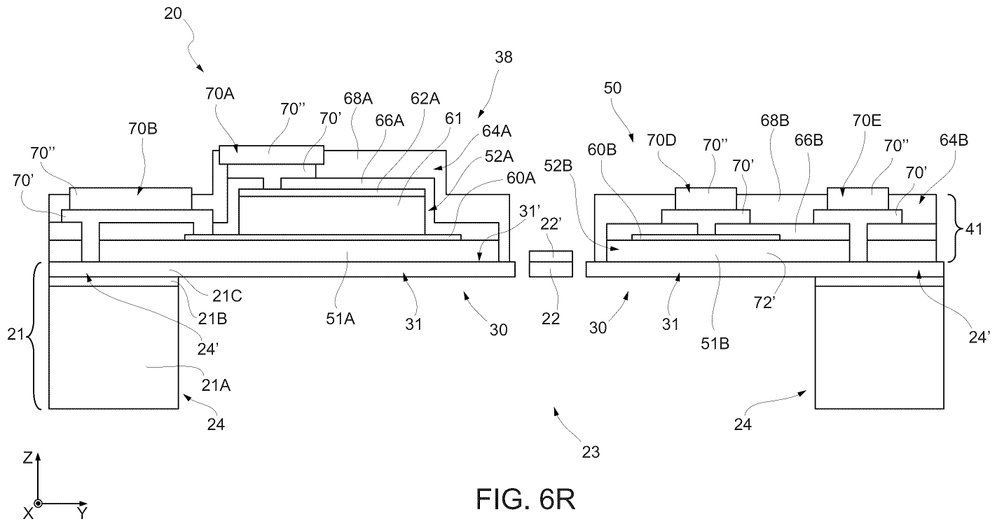

In detail, the electrical connections of the piezoelectric actuator 38 comprise a first actuation electrical connection 70A in direct physical and electrical coupling with the top actuation electrode 62A, a second actuation electrical connection 70B in direct physical and electrical coupling with the intermediate actuation electrode 60A, and a third actuation electrical connection 70C in direct physical and electrical coupling with the top semiconductive region 21C and therefore with the deformable main body 31. Optionally and as also considered in FIGS. 6A-6R, the second actuation electrical connection 70B and the third electrical connection 70C may be joined into a single actuation electrical connection (in FIGS. 6A-6R, identified by the reference 70B) in such a way that the intermediate actuation electrode 60A and the top semiconductive region 21C are short-circuited with each other and therefore, in use, are at the same electric potential.

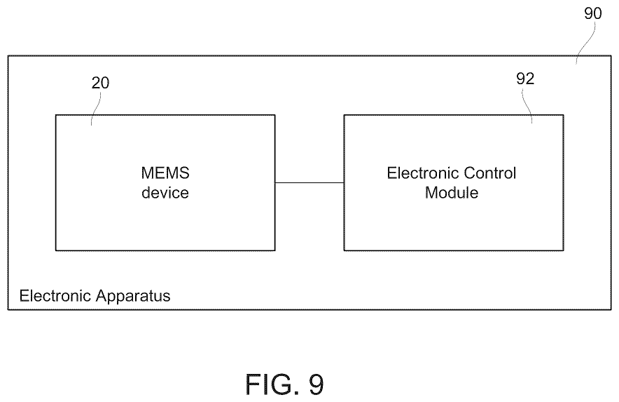

For example, each of these actuation electrical connections 70A-70C comprises a respective connection region 70′ and a respective contact pad 70″. The connection region 70′ is formed by a conductive layer, for example of aluminum, AlCu, copper or gold, which extends over at least part of the first insulating passivation layer 66A so as to be exposed from the latter, and which forms a protrusion traversing the first insulating passivation layer 66A and in direct electrical contact with the respective element to be electrically controlled (respectively the top actuation electrode 62A, the intermediate actuation electrode 60A and the deformable main body 31). Each contact pad 70″, of conductive material such as gold, extends over at least part of the second insulating passivation layer 68A so as to be exposed by the latter, forms a protrusion traversing the second insulating passivation layer 68A, and is in direct electrical contact with the respective connection region 70′ (therefore, by the latter it is in electrical contact with the respective element to be controlled electrically). The contact pads 70″ are coupeable in use to an electronic control module (shown in FIG. 9 with the reference 92), external to the MEMS device 20 and controllable as better described hereinbelow to bias the piezoelectric actuator 38 and to acquire signals coming from the strain sensor 50, by the contact pads 70″ and the connection regions 70′. For example, the contact pads 70″ and the connection regions 70′ may form part of the pads 40 and of the electric lines or vias 43, respectively, or may be independent therefrom.

With reference instead to the deformable structure 30 of FIG. 4 to the right of the tiltable structure 22, the piezoelectric sensor element 41 extends over the top surface 31′ of the deformable main body 31. In detail, the piezoelectric sensor element 41 and the portion of the deformable main body 31 having the piezoelectric sensor element 41 extending thereon together form the strain sensor 50.

The strain sensor 50 comprises an active detection structure 52B of the strain sensor 50, which is formed by a detection piezoelectric region 51B, a bottom detection electrode, and an intermediate detection electrode 60B.

The deformable main body 31 (in detail, the portion of the deformable main body 31 having the piezoelectric sensor element 41 extending thereon) forms the bottom detection electrode of the active detection structure 52B.

The detection piezoelectric region 51B is of the same piezoelectric material as the insulating piezoelectric region 51A (in detail AlN) and is arranged on the deformable main body 31, in contact with the latter.

The intermediate detection electrode 60B is of the same conductive material as the intermediate actuation electrode 60A and extends over the first detection piezoelectric region 51B, in contact with the latter.

Accordingly, the stack of the deformable main body 31, the first detection piezoelectric region 51B, and the intermediate detection electrode 60B forms a first detection capacitor 72′ of the active detection structure 52B of the strain sensor 50, which allows the position of the tiltable structure 22 to be detected by measuring the deformation of the deformable structure 30 piezoelectrically, as better described hereinbelow.

The piezoelectric sensor element 41 further comprises a respective passivation region 64B, similar to the passivation region 64A of the piezoelectric actuator 38. The passivation region 64B extends over the active detection structure 52B, over the detection piezoelectric region 51B where exposed by the top detection electrode 62B, and on the deformable main body 31 where exposed by the detection piezoelectric region 51B.

Similarly to what has been previously described, the passivation region 64B here comprises a respective first insulating passivation layer 66B (similar to the insulating passivation layer 66A and arranged on the active detection structure 52B, the detection piezoelectric region 51B, and the deformable main body 31) and a respective second insulating passivation layer 68B (similar to the second insulating passivation layer 68A and arranged on the first insulating passivation layer 66B).

In addition to the detection piezoelectric region 51B, the intermediate detection electrode 60B, and the passivation region 64B, the piezoelectric sensor element 41 also comprises respective electrical connections which allow in use the active detection structure 52B to be electrically controlled.

In detail, the electrical connections of the piezoelectric sensor element 41 comprise a first detection electrical connection 70D in direct physical and electrical coupling with the intermediate detection electrode 60B and a second detection electrical connection 70E in direct physical and electrical coupling with the top semiconductive region 21C and therefore with the deformable main body 31 which forms the bottom detection electrode of the active detection structure 52B. The shape and arrangement of the electrical connections of the piezoelectric sensor element 41 are entirely similar to those of the electrical connections of the piezoelectric actuator 38 and therefore are not described again in detail.

In use, each piezoelectric actuator 38 is biased, for example by the electronic control module 92, by applying respective bias electric potentials to the top actuation electrode 62A, the intermediate actuation electrode 60A, and the deformable main body 31, through the respective actuation electrical connections 70A-70C.

In particular, the intermediate actuation electrode 60A and the deformable main body 31 are set at a same reference electric potential (e.g., at ground, therefore at 0 V) so that the insulating piezoelectric region 51A is not biased and does not actively contribute to the deformation of the deformable structure 30.

Furthermore, the top actuation electrode 62A and the intermediate actuation electrode 60A are biased to different electric potentials and thus a bias electric voltage is applied between the top actuation electrode 62A and the intermediate actuation electrode 60A. The application of the bias electric voltage causes, due to the inverse piezoelectric effect, a mechanical deformation of the actuation piezoelectric region 61 of the actuation capacitor 56 and accordingly a deformation of the deformable structure 30, integral therewith.

Furthermore, the deformations of the deformable structures 30 caused by the action of the piezoelectric actuators 38 generate corresponding mechanical deformations in the strain sensors 50, integral with the deformable structures 30. Therefore, due to the direct piezoelectric effect, accumulations of charges of opposite sign are generated at the interfaces between the piezoelectric material and the conductive material of the first detection capacitors of the active detection structures 52B, and then a respective detection electric voltage is generated between the intermediate detection electrode 60B and the bottom detection electrode (the deformable main body 31) of each active detection structure 52B. Accordingly, each strain sensor 50 generates a respective detection signal (i.e. the detection electric voltage) which is linked to the deformation of the deformable structure 30 and therefore to the rotation of the tiltable structure 22 around the rotation axis A. The detection electric voltage of each strain sensor 50 is acquired, for example by the electronic control module 92, through the respective detection electrical connections 70D-70E.

In other words, the top semiconductive region 21C of the semiconductor body 21 operates as a bottom electrode for both the piezoelectric actuator 38 (where it causes no effect on the operation of the piezoelectric actuator 38, since it is set at the same electric potential as the intermediate actuation electrode 60A) and for the strain sensor 50 (where instead it is actively used).

Controlling the piezoelectric actuators 38, acquiring the detection signals generated by the strain sensors 50, and determining the position of the tiltable structure 22 starting from the acquired detection signals are performed in a suitable manner. For example, United States Patent Publication No. 2022/0335478 (corresponding to EP4075184 and incorporated herein by reference) discloses details regarding a differential acquisition of the detection signals of two piezoelectric sensors; nevertheless other types of acquisition are possible, for example single-ended acquisitions.

In general, the MEMS device 20 may be used by performing an operating method which comprises the following steps: biasing the intermediate actuation electrode 60A and the deformable main body 31 to the reference electric potential; applying a bias electric voltage between the top actuation electrode 62A and the intermediate actuation electrode 60A; and acquiring the first detection electric voltage generated by the strain sensor 50 and indicative of the deformation of the deformable structure 30.

An embodiment of a manufacturing process of the MEMS device 20 is now described, with reference to FIGS. 6A-6R which show steps successive to each other of the manufacturing process.

For illustrative and non-limiting example, the steps shown in FIGS. 6A-6R refer to the structure shown in FIG. 4. Nonetheless, the steps and considerations made below may similarly be applied to form the MEMS device 20 according to any of the embodiments previously discussed, as evident to the person skilled in the art.

FIG. 6A shows a cross-section of a work wafer 100, in the form of a SOI (Silicon On Insulator) wafer comprising the double structural layer previously described. The SOI wafer is formed in a suitable manner, for example starting from two wafers of semiconductor material (e.g., silicon) joined to each other at respective oxide layers (e.g., SiO₂).

The work wafer 100 has a first surface and a second surface 100′, 100″ opposite to each other along the axis Z, and comprises a bottom semiconductive region 100A of semiconductor material such as silicon, an intermediate insulating region 100B of insulating material such as silicon oxide, and a top semiconductive region 100C of semiconductor material such as silicon. The bottom semiconductive region 100A and the intermediate insulating region 100B are intended to form the fixed structure 24 which laterally delimits the cavity 23, while the top semiconductive region 100C is intended to form the deformable main body 31. In detail, the top semiconductive region 100C has the first surface 100′ of the work wafer 100, which is therefore intended to form the top surface 31′ of the deformable main body 31. In greater detail, the top semiconductive region 100C is of doped semiconductor material, such as monosilicon or doped polysilicon (e.g., with a doping species such as phosphorus), in such a way as to be conductive (e.g., to have electrical resistivity lower than, or equal to, about 30 mΩ·cm).

For example, the bottom semiconductive region 100A has a thickness along the axis Z comprised between about 400 μm and about 700 μm, the intermediate insulating region 100B has a thickness along the axis Z equal to about 1 μm, and the top semiconductive region 100C has a thickness along the axis Z comprised between about 10 μm and about 100 μm.

With reference to FIG. 6B, a first piezoelectric layer 102, of piezoelectric material and in particular of AlN, is formed on the first surface of the work wafer 100, for example having a thickness along the axis Z equal to about 1 μm. The first piezoelectric layer 102 is intended to form the insulating piezoelectric region 51A of the piezoelectric actuator 38 and the detection piezoelectric region 51B of the strain sensor 50. Forming the first piezoelectric layer 102 occurs for example, by deposition, in particular Physical Vapor Deposition (PVD).

With reference to FIG. 6C, a first conductive layer 104, of conductive material and in particular of metal material such as platinum, is formed (for example by deposition) on the first piezoelectric layer 102. The first conductive layer 104 has a thickness along the axis Z comprised between about 50 nm and about 200 nm. The first conductive layer 104 is intended to form the intermediate actuation electrode 60A of the piezoelectric actuator 38 and the intermediate detection electrode 60B of the strain sensor 50.

With reference to FIG. 6D, a second piezoelectric layer 106, of piezoelectric material such as PZT, for example having a thickness along the axis Z comprised between about 0.5 μm and about 3 μm, is formed (for example by deposition) on the first conductive layer 104. The second piezoelectric layer 106 is intended to form the actuation piezoelectric region 61 of the piezoelectric actuator 38.

With reference to FIG. 6E, a second conductive layer 108, of conductive material, in particular metal material such as platinum or titanium and tungsten alloy, is formed (for example by deposition), on the second piezoelectric layer 106. The second conductive layer 108 has a thickness along the axis Z comprised between about 50 nm and about 200 nm. The second conductive layer 108 is intended to form the top actuation electrode 62A of the piezoelectric actuator 38.

The first conductive layer 104, the second piezoelectric layer 106, and the second conductive layer 108 form a stack of layers which is patterned (FIGS. 6F and 6G) by lithographic steps and selective chemical etchings so that the first conductive layer 104 forms the intermediate actuation electrode 60A of the piezoelectric actuator 38 and the intermediate detection electrode 60B of the strain sensor 50, so that the second piezoelectric layer 106 forms the actuation piezoelectric region 61 of the piezoelectric actuator 38, and so that the second conductive layer 108 forms the top actuation electrode 62A of the piezoelectric actuator 38.

In particular, as visible in FIG. 6F, the top actuation electrode 62A and the underlying actuation piezoelectric region 61 are patterned in a first etching step and therefore have the same shape. In detail, during the first etching step a first mask (not shown) is used which covers a region of the second conductive layer 108 adapted to become the top actuation electrode 62A and which exposes the remaining part of the second conductive layer 108. For example, the first etching step is performed either by dry etching (for example, plasma-based etching) or wet etching (for example fluorine- or chlorine-based etching), to remove the exposed regions of the second conductive layer 108 and the second piezoelectric layer 106.

Furthermore, as visible in FIG. 6G, the intermediate actuation electrode 60A of the piezoelectric actuator 38 and the intermediate detection electrode 60B of the strain sensor 50 are patterned in a second etching step, successive to the first etching step. In detail, during the second etching step a second mask (not shown) is used which covers a first and a second region of the first conductive layer 104 adapted to become the intermediate actuation electrode 60A of the piezoelectric actuator 38 and the intermediate detection electrode 60B of the strain sensor 50, and which exposes the remaining part of the first conductive layer 104; for example, the first region of the first conductive layer 104 adapted to become the intermediate actuation electrode 60A of the piezoelectric actuator 38 is approximately underlying the top actuation electrode 62A and the actuation piezoelectric region 61, while the second region of the first conductive layer 104 adapted to become the intermediate detection electrode 60B of the strain sensor 50 extends laterally to the first region of the first conductive layer 104. For example, the second etching step is performed by dry etching, for example a chlorine-based etching, to remove the exposed regions of the first conductive layer 104.

The top actuation electrode 62A, the actuation piezoelectric region 61, and the intermediate actuation electrode 60A therefore form the active actuation structure 52A of the piezoelectric actuator 38.

With reference to FIG. 6H, a first insulating layer 110 is formed on the active actuation structure 52A of the piezoelectric actuator 38, on the intermediate detection electrode 60B of the strain sensor 50 and on the exposed regions of the first piezoelectric layer 102. The first insulating layer 110 is of insulating material such as aluminum oxide or silicon oxide and for example has a thickness along the axis Z comprised between about 100 nm and about 1 μm. The first insulating layer 110 is intended to form the first insulating passivation layers 66A of the piezoelectric actuator 38 and the strain sensor 50. Forming the first insulating layer 110 occurs for example by deposition, in particular Chemical Vapour Deposition (CVD) such as Plasma-Enhanced Chemical Vapor Deposition (PECVD) and/or Atomic Layer Deposition (ALD).

With reference to FIG. 6I, first electrical connection openings (or trenches) 112A, 112B and 112C are formed through the first insulating layer 110 in such a way as to partially expose the intermediate detection electrode 60B of the strain sensor 50, the top actuation electrode 62A of the piezoelectric actuator 38, and the intermediate actuation electrode 60A of the piezoelectric actuator 38. The first electrical connection openings 112A, 112B and 112C are lateral to each other and are intended to accommodate, at least partially, the connection regions 70′ of the electrical connections 70A, 70B and 70D in such a way that they may be in direct electrical contact respectively with the top actuation electrode 62A of the piezoelectric actuator 38, the intermediate actuation electrode 60A of the piezoelectric actuator 38, and the intermediate detection electrode 60B of the strain sensor 50.

The first electrical connection openings 112A, 112B and 112C are formed by lithographic steps and selective chemical etching. In particular, a third etching step is performed wherein a third mask (not shown) is used which exposes the regions of the first insulating layer 110 to be removed to form the first electrical connection openings 112A, 112B and 112C where the connection regions 70′ will be formed, and which covers the remaining parts of the first insulating layer 110. For example, the third etching step is performed either by dry etching (for example, plasma-based etching) or wet etching (for example, fluorine-based etching).

With reference to FIG. 6J, second electrical connection openings (or trenches) 114A, 114B and a first work opening (or trench) 114C are formed which extend through the first insulating layer 110 and the first piezoelectric layer 102 in such a way as to expose regions of the first surface 100′ of the work wafer 100. The second electrical connection openings 114A, 114B and the first work opening 114C are lateral to each other and with respect to the first electrical connection openings 112A, 112B and 112C. The second electrical connection openings 114A, 114B are intended to accommodate, at least partially, the connection regions 70′ of the electrical connections 70C and 70E in such a way that they may be in direct electrical contact with the top semiconductive region 100C of the work wafer 100. Instead, the first work opening 114C is intended to expose the portion of the top semiconductive region 100C of the work wafer 100 which will form the tiltable structure 22.

The second electrical connection openings 114A, 114B and the first work opening 114C are formed by lithographic steps and selective chemical etching. In particular, a fourth etching step is performed wherein a fourth mask (not shown) is used which exposes the regions of the first insulating layer 110 and the underlying regions of the first piezoelectric layer 102 to be removed to form both the second electrical connection openings 114A, 114B (where the connection regions 70′ will be formed) and the first work opening 114C (where the tiltable structure 22 will be formed), and which covers the remaining parts of the first insulating layer 110 and the first piezoelectric layer 102. For example, the fourth etching step is performed either by dry etching (for example, plasma-based etching) or wet etching (for example, fluorine-based etching).

The portions of the first insulating layer 110 remaining following the etchings of FIGS. 6I and 6J define the first insulating passivation layers 66A, 66B of the piezoelectric actuator 38 and the strain sensor 50.

Furthermore, the portions of the first piezoelectric layer 102 remaining following the etchings of FIGS. 61 and 6J define the insulating piezoelectric region 51A of the piezoelectric actuator 38 and the detection piezoelectric region 51B of the active detection structure 52B of the strain sensor 50, lateral and spaced from each other.

With reference to FIG. 6K, a third conductive layer 116 is formed on the first insulating passivation layers 66A, 66B of the piezoelectric actuator 38 and the strain sensor 50 and on the exposed regions of the intermediate detection electrode 60B of the strain sensor 50, the top actuation electrode 62A of the piezoelectric actuator 38, the intermediate actuation electrode 60A of the piezoelectric actuator 38, and the top semiconductive region 100C of the work wafer 100. The third conductive layer 116 is of conductive material such as aluminum, AlCu, copper or gold and, for example, has a thickness along the axis Z equal to about 0.5 μm. The third conductive layer 116 is intended to form the connection regions 70′ of the electrical connections 70A-70E. Forming the third conductive layer 116 occurs for example by deposition.

With reference to FIG. 6L, the third conductive layer 116 is patterned by lithographic steps and selective chemical etchings, in such a way as to form the connection regions 70′ of the electrical connections 70A-70E, physically spaced from each other.

In particular, this is done by a fifth etching step and using a fifth mask (not shown) which covers the regions of the third conductive layer 116 adapted to become the connection regions 70′ of the electrical connections 70A-70E and which exposes the remaining part of the third conductive layer 116. For example, the fifth etching step is performed either by dry etching (for example, plasma-based etching with chlorinated gases) or wet etching (for example, etching based on mixtures of nitric acid and phosphoric acid), to remove the exposed regions of the third conductive layer 116.

With reference to FIG. 6M, a second insulating layer 118 is formed on the connection regions 70′ of the electrical connections 70A-70E, on the first insulating passivation layers 66A, 66B of the piezoelectric actuator 38 and the strain sensor 50, and on the exposed region of the top semiconductive region 100C of the work wafer 100 which will form the tiltable structure 22. The second insulating layer 118 is of insulating and passivating material such as SiN and for example has a thickness along the axis Z comprised between about 100 nm and about 1 μm. The second insulating layer 118 is intended to form the second insulating passivation layers 68A, 68B of the piezoelectric actuator 38 and the strain sensor 50. Forming the second insulating layer 118 occurs for example by deposition (for example CVD).

With reference to FIG. 6N, the second insulating layer 118 is patterned by lithographic steps and selective chemical etchings, in such a way as to form the second insulating passivation layers 68A, 68B of the piezoelectric actuator 38 and the strain sensor 50.

This occurs by forming third electrical connection openings (or trenches) 120A-120D and a second work opening (or trench) 120E in the second insulating layer 118. The third electrical connection openings 120A-120D extend through the second insulating layer 118 in such a way as to at least partially expose the connection regions 70′ of the electrical connections 70A-70E, and are intended to accommodate, at least partially, the contact pads 70″ of the electrical connections 70A-70E in such a way that they may be in direct electrical contact with the respective connection regions 70′ of the electrical connections 70A-70E. The second work opening 120E extends through the second insulating layer 118 in such a way as to expose the portion of the top semiconductive region 100C of the work wafer 100 that will form the tiltable structure 22, therefore is substantially aligned with the first work opening 114C.

The third electrical connection openings 120A-120D and the second work opening 120E are formed by lithographic steps and selective chemical etching. In particular, a seventh etching step is performed wherein a seventh mask (not shown) is used which exposes the regions of the second insulating layer 118 to be removed to form both the third electrical connection openings 120A-120D (where the contact pads 70″ will be formed) and the second work opening 120E (where the tiltable structure 22 will be formed), and which covers the remaining parts of the second insulating layer 118. For example, the sixth etching step is performed by dry etching, in particular a plasma-based etching (e.g., a fluorine-based etching).

In this manner, the passivation regions 64A and 64B of the piezoelectric actuator 38 and the strain sensor 50 are also formed, as a union of the first insulating passivation layers 66A, 66B and the second insulating passivation layers 68A, 68B.

With reference to FIG. 6O, the contact pads 70″ of the electrical connections 70A-70E are formed in the third electrical connection openings 120A-120D and therefore in direct electrical contact with the connection regions 70′ of the electrical connections 70A-70E. This occurs similarly to forming the connection regions 70′ of the electrical connections 70A-70E and is therefore not described in detail again. Briefly, there is formed a fourth conductive layer (not shown and of a conductive material such as gold, for example with a thickness along the axis Z comprised between about 100 nm and about 500 nm), which is then patterned by lithographic steps and selective chemical etchings (e.g. by an eighth etching step and using an eighth mask) in such a way as to form the contact pads 70″ of the electrical connections 70A-70E, physically spaced from each other.

In this manner the electrical connections 70A-70E are formed.

Accordingly, both the strain sensor 50 and the piezoelectric actuator 38 are also formed.

With reference to FIG. 6P, the reflective surface 22′ of the mirror structure is formed on the exposed part of the top semiconductive region 100C of the work wafer 100 which will become the tiltable structure 22. This occurs similarly to forming the connection regions 70′ of the electrical connections 70A-70E and therefore it is not described again in detail. Briefly, there is formed a fifth conductive layer (not shown and of material reflecting the radiation such as aluminum or gold depending on whether the projection is in the visible or in the infrared), for example with a thickness along the axis Z equal to about 100 nm, which is then patterned by suitable lithographic steps and selective chemical etchings (e.g. a ninth etching step and using a ninth mask which covers the region of the fifth conductive layer intended to form the reflective surface 22′ and which exposes the remaining part of the fifth conductive layer) in such a way as to form the reflective surface 22′.

With reference to FIG. 6Q, a planar profile opening (or trench) 124 is formed through the top semiconductive region 100C of the work wafer 100 and down to reaching the intermediate insulating region 100B of the work wafer 100. The planar profile opening 124 physically separates the portions of the top semiconductive region 100C which are intended to form the tiltable structure 22 and the one or more deformable main bodies 31. In other words, in top view and therefore in the plane XY, the planar profile opening 124 partially surrounds the deformable main body 31 (i.e., it surrounds the deformable main body 31 except for the portion through which it is intended to be fixed to the fixed structure 24) and completely surrounds the reflective surface 22′. In this manner, the portions of the top semiconductive region 100C underlying the piezoelectric actuator 38 and the piezoelectric sensor element 41 (which will form the deformable main bodies 31) and the portion of the top semiconductive region 100C underlying the reflective surface 22′ (which will form the tiltable structure 22) are physically insulated (i.e. spaced) from each other and with respect to the remaining part of the top semiconductive region 100C which will form the fixed structure 24. In other words, the planar profile opening 124 defines the planar profile, in top view, of the movable parts of the MEMS device 20 which are suspended on the cavity 23.

The planar profile opening 124 is formed by lithographic steps and selective chemical etching. In particular, a tenth etching step is performed wherein a tenth mask (not shown) is used which exposes the exposed parts of the top semiconductive region 100C, to be removed to form the planar profile opening 124, and which covers the remaining parts of the piezoelectric actuator 38, the strain sensor 50 and the reflective surface 22′. For example, the tenth etching step is performed by dry etching, in particular a plasma-based etching, in greater detail a “Deep Reactive Ion Etching”, DRIE.

With reference to FIG. 6R, the cavity 23 is formed to define the mirror structure and the deformable structures 30 of suspended type, and therefore to obtain the MEMS device 20. In fact, after forming the cavity 23, the mirror structure and the deformable structures 30 are suspended on the cavity 23 and the remaining part of the work wafer 100 defines the anchoring structure.

In particular, the cavity 23 is formed by lithographic steps and selective chemical etching, starting from the second surface 100″ of the work wafer 100 and up to reaching the top semiconductive region 100C. In detail, this is done by an eleventh etching step wherein an eleventh mask (not shown) is used which exposes the parts of the bottom semiconductive region 100A and the superimposed intermediate insulating region 100B aligned along the axis Z with the piezoelectric actuator 38, the strain sensor 50 and the mirror structure, and which covers the remaining parts of the bottom semiconductive region 100A and the superimposed intermediate insulating region 100B adapted to form the fixed structure 24. For example, the eleventh etching step is performed by a selective chemical etching such as a dry chemical etching, for example by dry etching, in particular a plasma-based etching, in greater detail DRIE.

In general, the steps of FIGS. 6D-6F refer only to the manufacture of the piezoelectric actuator 38 and not also to the strain sensor 50.

Furthermore, the steps of FIGS. 6P-6Q (as well as forming the first work opening 114C in FIG. 6J and the second work opening 120E in FIG. 6N) refer only to the manufacture of the mirror structure.

Furthermore, the steps of FIGS. 6H-60 refer generically to forming the passivation regions 64A, 64B and the electrical connections 70A-70E of the piezoelectric actuator 38 and the strain sensor 50.

As shown in FIG. 9, the MEMS device 20 manufactured according to the previously described manufacturing process may be comprised in an electronic apparatus 90, which also comprises the electronic control module 92. The electronic control module 92 is operatively coupled to the MEMS device 20 and is configured to acquire the first detection electric voltage, generated by the strain sensor 50 and indicative of the deformation of the deformable structure 30, and electrically control the piezoelectric actuator 38 based on the first detection electric voltage (e.g., in closed-loop).

From an examination of the characteristics of this disclosure, the advantages afforded are evident.

In particular, the MEMS device 20 allows both to actuate a deformation structure piezoelectrically and to monitor its deformation, again piezoelectrically. This allows the position of the tiltable structure 22 to be controlled more accurately.

The strain sensor 50 is based on AlN and therefore has electrical measurement performances higher than the corresponding known cases based on other piezoelectric materials such as PZT.

Furthermore, the use of the deformable main body 31 as a bottom detection electrode of the active detection structure 52B allows to actively use (i.e. for detection purposes) an insulating material layer which would in any case be present for reasons of manufacture and use of the piezoelectric sensors. This allows the strain sensor 50 to be formed using a smaller number of manufacturing steps with respect to some known solutions. Furthermore, without the need to increase the number of manufacturing steps with respect to other known solutions, this allows to have the active piezoelectric layers of the piezoelectric actuator 38 and the strain sensor 50 which are of different materials (e.g., PZT for the piezoelectric actuator 38 and AlN for the strain sensor 50) and therefore allows to achieve the simultaneous optimization of both the actuation performances and the detection performances of the MEMS device 20.

These advantages are particularly useful in case the MEMS device 20 is a mirror device, since they allow a mirror device with optimized electrical and use performances to be manufactured at a low cost.

Finally, it is clear that modifications and variations may be made without thereby departing from the scope of this disclosure, as defined in the attached claims. For example, the different embodiments described may be combined with each other so as to provide further solutions.

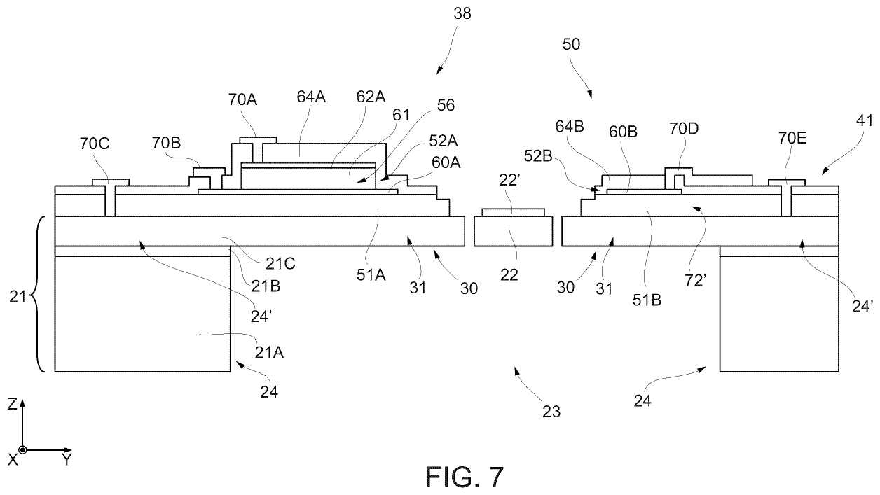

Furthermore, FIG. 7 shows a different embodiment of the MEMS device 20.

The structure of the MEMS device 20 of FIG. 7 is similar to that of the MEMS device 20 of FIG. 4.

However, in FIG. 7 the passivation regions 64A, 64B of the piezoelectric actuator 38 and the strain sensor 50 are monolithic and made entirely of a single material (i.e. they do not comprise a stack of insulating passivation layers), as well as the electrical connections 70A-70E (which for example are entirely of gold). This further simplifies the manufacturing process of the MEMS device 20. Furthermore, the use of gold to form the electrical connections 70A-70E reduces the risk of corrosion of the same in the presence of humidity.

Optionally, in FIG. 7 the passivation regions 64A, 64B of the piezoelectric actuator 38 and the strain sensor 50 are also of AlN, like the insulating piezoelectric region 51A and the detection piezoelectric region 51B. This improves the mechanical strength of the MEMS device 20 and above all simplifies the manufacturing process of the same and reduces the costs thereof, since fewer materials and fewer steps are required for the manufacturing of the MEMS device 20 (e.g., the third conductive layer 116 may be of material such as gold and the manufacturing steps of FIGS. 6M-60 may be omitted).

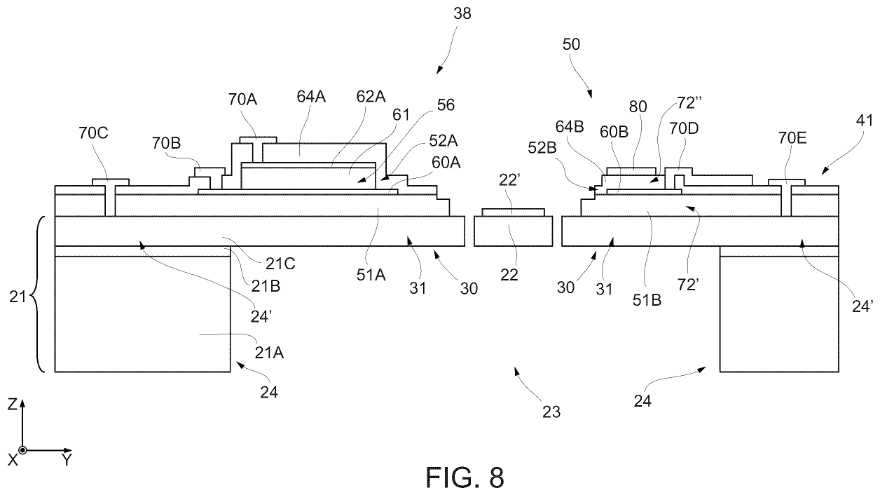

Furthermore, FIG. 8 shows a further embodiment of the MEMS device 20.

The structure of the MEMS device 20 of FIG. 8 is similar to that of the MEMS device 20 of FIG. 7, with the passivation regions 64A, 64B of the piezoelectric actuator 38 and the strain sensor 50 which are monolithic and formed of AlN.

Furthermore, the strain sensor 50 of the MEMS device 20 of FIG. 8 also comprises a top detection electrode 80 which extends over the passivation region 64B of the strain sensor 50, physically spaced from the detection electrical connections 70D-70E and therefore not in direct electrical contact therewith. In detail, the top detection electrode 80, the intermediate detection electrode 60B and the bottom detection electrode (i.e. the top semiconductive region 21C and therefore with the deformable main body 31) of the active detection structure 52B are superimposed on each other along the axis Z.

The top detection electrode 80 defines, together with the passivation region 64B of AlN and the intermediate detection electrode 60B, a second detection capacitor 72″ of the active detection structure 52B of the strain sensor 50. In practice, in FIG. 8 the active detection structure 52B of the strain sensor 50 comprises both the first and the second detection capacitors 72′, 72″ which share the intermediate detection electrode 60B and which are therefore electrically connected in series with each other.

In particular, the top detection electrode 80 is similar to the intermediate detection electrode 60B and is of conductive material, in particular metal material such as platinum or gold, and extends over the passivation region 64B of AlN 64B, in contact with the latter.

The presence of the first and the second detection capacitors 72′, 72″ in series with each other allows the sensitivity of the measurement of the position of the tiltable structure 22 to be increased without complicating the manufacturing process of the MEMS device 20.

In fact, the top detection electrode 80 may, for example, be formed with the same material as the electrical connections 70A-70E, during the manufacturing of the latter (e.g., manufacturing step of FIG. 6L). Accordingly, no additional masks or manufacturing steps are required since it is sufficient for the fifth mask to also cover the region of the third conductive layer 116 adapted to become the top detection electrode 80.

In general, the MEMS device 20 is not to be understood as limited to the case of a MEMS mirror device, but may be a generic MEMS device comprising at least one deformable structure 30 actuated piezoelectrically, whose position is desired to be accurately and piezoelectrically detected. This deformable structure 30 comprises the respective deformable main body 31 suspended on the cavity and, on the deformable main body 31, at least one piezoelectric sensor element 41 and at least one piezoelectric actuator 38 arranged side by side to each other, similarly to what has been previously described. For example, the MEMS device may also be a speaker device, an optical lens device, or a Piezoelectric Micromachined Ultrasonic Transducer (PMUT) device.

Furthermore, although the case in which the semiconductor body 21 is a double structural layer formed by a processed SOI wafer has been previously considered, the semiconductor body 21 may also be a die of semiconductor material, in particular mono- or polycrystalline silicon. In general, the semiconductor body 21 comprises the bottom semiconductive region 21A, of semiconductor material such as silicon and which defines the fixed structure 24 and delimits the cavity 23, and the top semiconductive region 21C, of semiconductor material such as silicon, superimposed on the bottom semiconductive region 21A and which defines the deformable main body 31 suspended on the cavity 23. Furthermore, the semiconductor body 21 is formed starting from the work wafer 100 which generally comprises the bottom semiconductive region 100A, of semiconductor material such as silicon and intended to form the fixed structure 24 and to delimit the cavity 23, and the top semiconductive region 100C, of semiconductor material such as silicon, superimposed on the bottom semiconductive region 100A and intended to form the deformable main body 31 suspended on the cavity 23.

1. A MEMS device, comprising:
a semiconductor body including a fixed structure and a deformable main body, the fixed structure defining a cavity in the semiconductor body and the deformable main body being fixed to the fixed structure and suspended over the cavity;
a piezoelectric actuator extending over the deformable main body; and
a piezoelectric sensor element which extends over the deformable main body, laterally to the piezoelectric actuator, and which forms, with the deformable main body, a strain sensor;
wherein the piezoelectric sensor element comprises:
a detection piezoelectric region of aluminum nitride, extending over the deformable main body; and
an intermediate detection electrode extending over the detection piezoelectric region;
wherein the deformable main body, the detection piezoelectric region, and the intermediate detection electrode form a first detection capacitor of an active detection structure of the strain sensor, the deformable main body being configured to operate as a bottom detection electrode of the first detection capacitor;
wherein the deformable main body, the piezoelectric actuator, and the piezoelectric sensor element form a deformable structure suspended on the cavity;
wherein the piezoelectric actuator is electrically controllable to generate a deformation of the deformable structure; and
wherein the active detection structure of the strain sensor is configured to generate, in response to the deformation of the deformable structure, a first detection electric voltage between the bottom detection electrode and the intermediate detection electrode of the first detection capacitor, the first detection electric voltage being indicative of the deformation of the deformable structure.

2. The MEMS device according to claim 1, wherein the piezoelectric sensor element further comprises:
a passivation region of insulating material extending over the intermediate detection electrode;
a first detection electrical connection of conductive material extending through the passivation region of the piezoelectric sensor element and in electrical contact with the intermediate detection electrode; and
a second detection electrical connection of conductive material extending through the passivation region of the piezoelectric sensor element, in electrical contact with the deformable main body and electrically insulated from the first detection electrical connection.

3. The MEMS device according to claim 2, wherein the passivation region is monolithic and comprised of aluminum nitride.

4. The MEMS device according to claim 3,
wherein the piezoelectric sensor element further comprises a top detection electrode extending over the passivation region;
wherein the top detection electrode, the passivation region, and the intermediate detection electrode form a second detection capacitor of the active detection structure of the strain sensor, the first detection capacitor and the second detection capacitor being electrically connected in series with each other; and
wherein the active detection structure of the strain sensor is further configured to generate, in response to the deformation of the deformable structure, a second detection electric voltage between the intermediate detection electrode and the top detection electrode of the second detection capacitor, the second detection electric voltage being indicative of the deformation of the deformable structure.

5. The MEMS device according to claim 1, wherein the deformable main body is comprised of doped semiconductor material and has an electrical resistivity of no more than 30 mΩ·cm.

6. The MEMS device according to claim 1, wherein the piezoelectric actuator includes:
an insulating piezoelectric region of aluminum nitride extending over the deformable main body laterally to the detection piezoelectric region;
an intermediate actuation electrode of conductive material extending over the insulating piezoelectric region;
an actuation piezoelectric region of piezoelectric material extending over the intermediate actuation electrode; and
a top actuation electrode of conductive material extending over the actuation piezoelectric region;
wherein the intermediate actuation electrode, the actuation piezoelectric region, and the top actuation electrode form an actuation capacitor of an active actuation structure of the piezoelectric actuator.

7. The MEMS device according to claim 6, wherein the piezoelectric actuator further comprises:
a respective passivation region of insulating material extending over the top actuation electrode;
a first actuation electrical connection of conductive material extending through the passivation region of the piezoelectric actuator and in electrical contact with the top actuation electrode; and
a second actuation electrical connection of conductive material extending through the passivation region of the piezoelectric actuator and electrically insulated from the first actuation electrical connection;
wherein the second actuation electrical connection is in electrical contact with the deformable main body and with the intermediate actuation electrode.

8. The MEMS device according to claim 6, wherein the piezoelectric actuator further comprises:
a respective passivation region of insulating material extending over the top actuation electrode;
a first actuation electrical connection of conductive material extending through the passivation region of the piezoelectric actuator and in electrical contact with the top actuation electrode; and
a second actuation electrical connection of conductive material extending through the passivation region of the piezoelectric actuator and electrically insulated from the first actuation electrical connection;
wherein the second actuation electrical connection is in electrical contact with the intermediate actuation electrode and the piezoelectric actuator further comprises a third actuation electrical connection of conductive material, which extends through the passivation region of the piezoelectric actuator, is electrically insulated from the first actuation electrical connection and the second actuation electrical connection and is in electrical contact with the deformable main body.

9. The MEMS device according to claim 1, wherein the MEMS device is of mirror type and further comprises:
a tiltable structure elastically suspended on the cavity;
a first support arm and a second support arm extending along a rotation axis of the tiltable structure between the fixed structure and opposite sides of the tiltable structure; and
a plurality of said deformable structures, which face opposite sides of the first support arm, extend between the fixed structure and said opposite sides of the first support arm and are electrically controllable to deform mechanically to thereby generate a rotation of the tiltable structure around the rotation axis;
wherein the strain sensors of the deformable structures are opposite to each other with respect to the rotation axis; and
wherein, when the tiltable structure rotates around the rotation axis due to the deformable structures, the strain sensors of the deformable structures undergo respective mechanical deformations and generate respective detection signals which are indicative of the rotation of the tiltable structure around the rotation axis and are in phase-opposition to each other.

10. The MEMS device according to claim 1, wherein the MEMS device is of mirror type and further comprises:
a tiltable structure elastically suspended on the cavity;
a first support arm and a second support arm extending along a rotation axis of the tiltable structure between the fixed structure and opposite sides of the tiltable structure; and
a plurality of said deformable structures which face opposite sides of the first support arm, extend between the fixed structure and the tiltable structure, and are electrically controllable to deform mechanically to thereby generate a rotation of the tiltable structure around the rotation axis;
wherein the strain sensors of the deformable structures are opposite to each other with respect to the rotation axis; and
wherein, when the tiltable structure rotates around the rotation axis due to the deformable structures, the strain sensors of the deformable structures undergo respective mechanical deformations and generate respective detection signals which are indicative of the rotation of the tiltable structure around the rotation axis and are in phase-opposition to each other.

11. A method of manufacturing a MEMS device, comprising steps of:
a) forming a first piezoelectric layer of aluminum nitride on a first surface of a work wafer comprising a bottom semiconductive region of semiconductor material and a top semiconductive region of semiconductor material, superimposed along a first axis on the bottom semiconductive region of the work wafer and defining said first surface of the work wafer, the work wafer also having a second surface opposite to the first surface along the first axis;
b) forming, on the first piezoelectric layer, a first conductive layer of conductive material;
f) patterning, by chemical etching, the first conductive layer so as to form an intermediate detection electrode of a strain sensor;
i) forming, by chemical etching, a first work trench through the first piezoelectric layer and up to, and exposing, the top semiconductive region of the work wafer, wherein the first work trench surrounds, orthogonally to the first axis, a portion of the first piezoelectric layer which underlies the intermediate detection electrode along the first axis and which forms a detection piezoelectric region;
p) forming, by chemical etching, a planar profile trench through the top semiconductive region of the work wafer, the planar profile trench partially surrounding, orthogonally to the first axis, a portion of the top semiconductive region of the work wafer, underlying the detection piezoelectric region and adapted to form a deformable main body, and physically separating, orthogonally to the first axis, part of said portion of the top semiconductive region from a remaining part of the top semiconductive region of the work wafer in such a way as to define, orthogonally to the first axis, a planar profile of the deformable main body; and
q) removing, by chemical etching performed starting from the second surface of the work wafer, a portion of the bottom semiconductive region of the work wafer underlying the deformable main body, up to exposing the top semiconductive region of the work wafer, in such a way as to form a cavity.

12. The method according to claim 11, further comprising, between steps b) and f), the steps of:
c) forming, on the first conductive layer, a second piezoelectric layer of piezoelectric material;
d) forming, on the second piezoelectric layer, a second conductive layer of conductive material; and
e) patterning, by chemical etching, the second conductive layer and the second piezoelectric layer in such a way as to form, respectively, a top actuation electrode and an actuation piezoelectric region underlying a top actuation electrode along the first axis, and
wherein step f) further comprises forming an intermediate actuation electrode of the piezoelectric actuator laterally to, and spaced from, an intermediate detection electrode of the strain sensor.

13. The method according to claim 12, comprising, between steps f) and i), the step of forming a passivation region on the intermediate detection electrode of a piezoelectric sensor element, on a first detection electrical connection, and on a second detection electrical connection through the passivation region.

14. The method according to claim 13,
wherein the step of forming the passivation region on the intermediate detection electrode and the first detection electrical connection and the second detection electrical connection through the passivation region comprises, between steps f) and i), comprises the steps of:
g) forming a first insulating layer of insulating material on the intermediate detection electrode of the strain sensor and on the first piezoelectric layer;
h) forming a first electrical connection trench through the first insulating layer in such a way as to partially expose the intermediate detection electrode;
wherein step i) comprises forming the first work trench also through the first insulating layer, the first work trench also surrounding, orthogonally to the first axis, a portion of the first insulating layer, superimposed on the intermediate detection electrode along the first axis, which forms a first insulating passivation layer of the passivation region of the piezoelectric sensor element;
wherein step i) further comprises forming a second electrical connection trench through the first insulating layer and the first piezoelectric layer in such a way as to partially expose the top semiconductive region of the work wafer, and
wherein the step of forming the passivation region on the intermediate detection electrode and the first detection electrical connection and the second detection electrical connection through the passivation region also comprises, between steps i) and p), the steps of:
j) forming a third conductive layer of conductive material on the first insulating passivation layer of the passivation region of the piezoelectric sensor element, on the intermediate detection electrode and on the top semiconductive region of the work wafer;
k) patterning, by chemical etching, the third conductive layer in such a way as to form, starting from the third conductive layer, a connection region of the first detection electrical connection in the first electrical connection trench, and a connection region of the second detection electrical connection in the second electrical connection trench;
l) forming a second insulating layer of insulating material on the first insulating passivation layer, the first detection electrical connection and the second detection electrical connection, the second insulating layer defining a second insulating passivation layer of the passivation region of the piezoelectric sensor element and forming together with the first insulating passivation layer said passivation region of the piezoelectric sensor element;
m) forming third electrical connection trenches through the second insulating layer in such a way as to partially expose the connection regions of the first detection electrical connection and the second detection electrical connection; and
n) forming respective contact pads of the first detection electrical connection and the second detection electrical connection, of conductive material, in the third electrical connection trenches and in electrical contact with the respective connection regions, each contact pad forming with the respective connection region the first detection electrical connection or, respectively, the second detection electrical connection.

15. The method according to claim 13,
wherein the step of forming the passivation region on the intermediate detection electrode and the first detection electrical connection and the second detection electrical connection through the passivation region comprises steps of:
g) forming a first insulating layer of aluminum nitride on the intermediate detection electrode of the strain sensor and on the first piezoelectric layer; and
h) forming a first electrical connection trench through the first insulating layer in such a way as to partially expose the intermediate detection electrode;
wherein step i) comprises forming the first work trench also through the first insulating layer, the first work trench also surrounding, orthogonally to the first axis, a portion of the first insulating layer, superimposed on the intermediate detection electrode along the first axis, which forms the passivation region of the piezoelectric sensor element,
wherein step i) further comprises forming a second electrical connection trench through the first insulating layer and the first piezoelectric layer in such a way as to partially expose the top semiconductive region of the work wafer; and
wherein the step of forming the passivation region on the intermediate detection electrode and the first detection electrical connection and the second detection electrical connection through the passivation region further comprises, between steps i) and p), the steps of:
j) forming a third conductive layer of conductive material on the passivation region of the piezoelectric sensor element, on the intermediate detection electrode and on the top semiconductive region of the work wafer; and
k) patterning, by chemical etching, the third conductive layer in such a way as to form, starting from the third conductive layer, the first detection electrical connection in the first electrical connection trench, the second detection electrical connection in the second electrical connection trench and a top detection electrode on the passivation region of the piezoelectric sensor element.

16. The method according to claim 15, further comprising steps of:
forming a tiltable structure elastically suspended on the cavity;
forming a first support arm and a second support arm extending between a fixed structure and opposite sides of the tiltable structure, along a rotation axis of the tiltable structure; and
forming a plurality of a deformable structures which face opposite sides of the first support arm, extend between the fixed structure and said opposite sides of the first support arm or between the fixed structure and the tiltable structure, and are electrically controllable to deform mechanically thereby generating a rotation of the tiltable structure around the rotation axis;
wherein strain sensors of the deformable structures are opposite to each other with respect to the rotation axis; and
wherein, when the tiltable structure rotates around the rotation axis due to the deformable structures, the strain sensors of the deformable structures undergo respective mechanical deformations and generate respective detection signals which are indicative of the rotation of the tiltable structure around the rotation axis and are in phase-opposition to each other.

17. An electronic apparatus comprising a MEMS device, the MEMS device comprising:
a semiconductor body including a fixed structure and a deformable main body, the fixed structure defining a cavity in the semiconductor body and the deformable main body being fixed to the fixed structure and suspended over the cavity;
a piezoelectric actuator extending over the deformable main body; and
a piezoelectric sensor element which extends over the deformable main body, laterally to the piezoelectric actuator, and which forms, with the deformable main body, a strain sensor;
wherein the piezoelectric sensor element comprises:
a detection piezoelectric region of aluminum nitride extending over the deformable main body; and
an intermediate detection electrode extending over the detection piezoelectric region;
wherein the deformable main body, the detection piezoelectric region, and the intermediate detection electrode form a first detection capacitor of an active detection structure of the strain sensor, the deformable main body being configured to operate as a bottom detection electrode of the first detection capacitor;
wherein the deformable main body, the piezoelectric actuator, and the piezoelectric sensor element form a deformable structure suspended on the cavity;
wherein the piezoelectric actuator is electrically controllable to generate a deformation of the deformable structure; and
wherein the active detection structure of the strain sensor is configured to generate, in response to the deformation of the deformable structure, a first detection electric voltage between the bottom detection electrode and the intermediate detection electrode of the first detection capacitor, the first detection electric voltage being indicative of the deformation of the deformable structure;
wherein the piezoelectric actuator includes:
an insulating piezoelectric region of aluminum nitride extending over the deformable main body laterally to the detection piezoelectric region;
an intermediate actuation electrode of conductive material extending over the insulating piezoelectric region;
an actuation piezoelectric region of piezoelectric material extending over the intermediate actuation electrode; and
a top actuation electrode of conductive material extending over the actuation piezoelectric region;
wherein the intermediate actuation electrode, the actuation piezoelectric region, and the top actuation electrode form an actuation capacitor of an active actuation structure of the piezoelectric actuator; and
circuitry configured to:
bias the intermediate actuation electrode and the deformable main body to a reference electric potential;
apply a bias electric voltage between the top actuation electrode and the intermediate actuation electrode; and
acquire the first detection electric voltage generated by the strain sensor and indicative of the deformation of the deformable structure.

18. The electronic apparatus of claim 17, further comprising: an electronic control module operatively coupled to the MEMS device and configured to acquire the first detection electric voltage, generated by the strain sensor and indicative of the deformation of the deformable structure, and to electrically control the piezoelectric actuator based on the first detection electric voltage.

19. The electronic apparatus of claim 17, wherein the piezoelectric sensor element further comprises:
a passivation region of insulating material extending over the intermediate detection electrode;
a first detection electrical connection of conductive material extending through the passivation region of the piezoelectric sensor element and in electrical contact with the intermediate detection electrode; and
a second detection electrical connection of conductive material extending through the passivation region of the piezoelectric sensor element, in electrical contact with the deformable main body and electrically insulated from the first detection electrical connection.

20. The electronic apparatus of claim 19,
wherein the passivation region is monolithic and comprised of aluminum nitride;
wherein the piezoelectric sensor element further comprises a top detection electrode extending over the passivation region;
wherein the top detection electrode, the passivation region, and the intermediate detection electrode form a second detection capacitor of the active detection structure of the strain sensor, the first detection capacitor and the second detection capacitor being electrically connected in series with each other; and
wherein the active detection structure of the strain sensor is further configured to generate, in response to the deformation of the deformable structure, a second detection electric voltage between the intermediate detection electrode and the top detection electrode of the second detection capacitor, the second detection electric voltage being indicative of the deformation of the deformable structure.
